(19) United States
(12) Patent Application Publication
(10) Pub. No.: US 2004/0033021 A1
(43) Pub. Date: Feb. 19, 2004

(54) Wavelength stabilized module, stable wavelength laser beam generating device and optical communication system

(76) Inventors: Hitoshi Oguri, Tokyo (JP); Junichiro Ichikawa, Tokyo (JP); Masayuki Ichioka, Tokyo (JP); Takeshi Sakai, Tokyo (JP); Tokutaka Hara, Tokyo (JP); Taizo Nakajima, Tokyo (JP); Kenichi Kubodera, Tokyo (JP)

Correspondence Address: FOLEY AND LARDNER, SUITE 500, 3000 K STREET NW, WASHINGTON, DC, 20007, US

(21) Appl. No.: 10/381,667

(22) PCT Filed: Sep. 27, 2001
(86) PCT No.: PCT/JP01/08453

(30) Foreign Application Priority Data
Sep. 28, 2000 (JP) 2000-295928
Mar. 23, 2001 (JP) 2001-86200
Sep. 11, 2001 (JP) 2001-275359

(51) Int. Cl. G02B 6/34; G02B 6/26

(52) U.S. Cl. 385/37; 385/27

(57) ABSTRACT

A wavelength stabilization module which can restrain light reflected by the fiber grating from returning to a light source, and a stable wavelength laser beam generating device. A wavelength stabilization module of the invention comprises an optical splitter 122 for splitting light lead from a light source 110 through a fiber 143 into first and second lights, a fiber grating 210 which has light of a specific wavelength in the first light pass therethrough and reflects light of the other wavelengths in the first light, and a light quantity change operating unit 311 for detecting a change in quantity of light passing through the fiber grating using the second light as reference light, and is configured to direct light, reflected by the fiber grating 210, to the outside of the fiber, and is configured to feed back the detected change in light quantity to the light source 110.

### TECHNICAL FIELD

This invention relates to a wavelength stabilization module, a stable wavelength laser beam generating device and an optical communication system which use a fiber grating.

### BACKGROUND ART

A wavelength stabilization module as shown in FIG. 29 has been conventionally used. In such a device, light from an optical device 1 is output through a fiber 2 and split to a fiber 4 and a fiber 5 by an optical coupler 3. A main signal 8a is transmitted through the fiber 4. Part of the main signal 8a is extracted as a monitor signal 8b to the fiber 5. A fiber Bragg grating (which will be hereinafter referred to simply as “fiber grating” or “FBG”) 6 which passes light of a specific wavelength and reflects light 8c of the other wavelengths is provided in the fiber 5. The light passing through FBG 6 is input into a wavelength control part 7 connected to the optical device 1 which controls and is used to control the wavelength of light which the optical device 1 emits to be constant.

In such a wavelength stabilization module, however, the FBG 6 reflects the light 8c which does not pass therethrough. The reflected light 8c is returned to the optical device 1 through the fiber 5, the optical coupler 3 and the fiber 2, and may adversely affect the light source, especially a laser source.

It is, therefore, an object of the present invention to provide a wavelength stabilization module using a fiber grating which can restrain light reflected by the fiber grating from returning to a light source, and a stable wavelength laser beam generating device using such a wavelength stabilization module. Another object of the present invention is to provide a wavelength stabilization module capable of locking the wavelength with a simple structure and an optical communication system using such a wavelength stabilization module.

### DISCLOSURE OF INVENTION

In accomplishing the above objects, a wavelength stabilization module according to the invention comprises, as shown e.g. in FIG. 1, an optical splitter 122 for splitting light lead from a light source 110 through a fiber 143 into first and second lights; a fiber grating 210 which transmits light of a specific wavelength in the first light and reflects light of the other wavelengths in the first light; and a light quantity change operating unit 311 for detecting a change in quantity of light passing through the fiber grating using the second light as reference light; and is configured to direct light, reflected by the fiber grating 210, to the outside of the fiber; and is configured to feed back the detected change in light quantity to the light source 110.

Since the light reflected by the fiber grating 210 is directed to the outside of the fiber, it is possible to restrain the reflected light from returning to a light source 110.

In the wavelength stabilization module, the configuration for directing the reflected light to the outside of the fiber may be a refractive index change part arranged inclined with respect to the direction perpendicular to the optical axis of a fiber 144 in which the fiber grating 210 is formed.

The wavelength stabilization module may comprise reflected light removing means for removing reflected light directed from the fiber grating 210 toward the light source 110.

In the wavelength stabilization module, the reflected light removing means may be high-refractive index material layers 126a and 126a′ provided on a surface of a cladding layer constituting the fiber between the fiber grating 210 and the light source 110.

The refractive index of the high-refractive index material is typically higher than that of the cladding layer, preferably equivalent to that of the core of the fiber. The high-refractive index material layers may be provided in the form of a film or a mass. The high-refractive index material is typically an adhesive.

In the wavelength stabilization module, the high-refractive index material layer 126a′ may be provided on the outer side of a bent portion of the fiber. Since there is a high-refractive index material layer on the outer side of a bent portion of the fiber, the returned light enters the high-refractive index material layer at a large angle and directed to the high-refractive index material.

In the wavelength stabilization module, the optical splitter 122 is preferably an optical coupler formed by fusing cores of two fibers, and the high-refractive index material layers 126a and 126b are preferably provided on a taper portion on the side of the fiber grating located in the vicinity of the fused region of the fibers. More preferably, the high-refractive index material layers 126a and 126b are each provided on the outer side of a bent portion of the fiber.

When the high-refractive index material layers are provided on a taper portion on the side of the fiber grating located in the vicinity of the fused region of the fibers, light is not directed to the outside in going out of the optical coupler but is when it returns thereinto.

In the wavelength stabilization module, the reflected light removing means may be a cladding layer-removed section 143d provided in the cladding layer 143b constituting the fiber 143 between the fiber grating 210 and the light source 110 as shown e.g. in FIG. 6(c).

In the wavelength stabilization module, the cladding layer-removed section 143d has a cladding layer 143e left to cover the core 143a. Since there remains a clad layer 143e, light can hardly escape from the core to the outside.

In the wavelength stabilization module, a high-refractive index material 143f may be filled in the cladding layer-removed section 143d in place of the removed cladding layer. This makes light transmitted through the cladding layer escape to the high-refractive index material easily.

In accomplishing the above objects, a stable wavelength laser beam generating device according to the invention comprises, as shown e.g. in FIG. 1, any one of the above wavelength stabilization modules; a light source 110 for generating a laser beam to be supplied to the wavelength stabilization module; and a controller 310 for controlling the wavelength of the laser beam which the light source 110 generates according to the change in light quantity provided as feedback.

The stable wavelength laser beam generating device, which is provided with a controller for controlling the wavelength of the laser beam, which the light source generates, according to the change in light quantity provided as feedback, can keep the wavelength of the laser beam constant.

In accomplishing the above objects, a wavelength stabilization module according to the invention comprises, as shown e.g. in FIG. 14, a first optical splitter 121 for splitting an input signal into a main signal and a monitor signal at a first specified splitting ratio; a second optical splitter 122 which receives the monitor signal and splits the monitor signal into an FBG input signal and a termination signal at a second specified splitting ratio; and a fiber grating 225 formed in an optical fiber 144 for transmitting the FBG input signal. The first and second specified splitting ratios are so selected that light reflected by the fiber grating 225 may be sufficiently attenuated in returning through the second optical splitter 122 and the first optical splitter 121 in the direction from which the input signal came.

Since light reflected by the fiber grating 225 may be sufficiently attenuated in returning in the direction from which the input signal came through the first and second optical splitters 121 and 122, it is possible to restrain the reflected light from returning to a laser source 110. To be “sufficiently attenuated” herein means e.g. to be attenuated by −35 dB with respect to the intensity of the input signal.

In the wavelength stabilization module, the first and second specified splitting ratios are preferably respectively 90% or more to 10% or less (at least about 10 dB). More preferably, the sum of the first and second specified ratios is 26 dB or more. For example, when one of the ratios is 90% to 10% (10 dB), the other should be 97.5% or more to 2.5% or less (at least 16 dB). Then, the light reflected by the fiber grating can be sufficiently attenuated with respect to the input signal.

Preferably, the second optical splitter 122 is provided with a first photodetector 123 for measuring light passing through the fiber grating 225 and a second photodetector 130 for measuring light reflected by the fiber grating 225. Then, there can be obtained a wavelength stabilization module which can be easily connected to the controller 310 for controlling the wavelength of a laser beam which the laser source 110 generates with the photodetectors 123 and 130.

Preferably, the termination signal is terminated. Since return light of the termination signal is eliminated, it is possible to restrain the reflected light from returning to the laser source 110.

In accomplishing the above objects, a stable wavelength laser beam generating device according to the invention comprises, as shown in e.g. FIG. 14, any one of the above wavelength stabilization modules; a laser source 110 for generating a laser beam to be supplied to the wavelength stabilization module; and a controller 310 which receives light processed by the wavelength stabilization module and controls the wavelength of the laser beam which the laser source 110 generates. Since the wavelength stabilization module restrains the reflected light from returning to the laser source, the controller exhibits stable wavelength controlling properties when it receives light processed by the wavelength stabilization module and stabilizes the wavelength of the laser beam which the laser source generates. Especially in the wavelength stabilization module according to claim 13, when the first and second specified ratios are respectively set to 90% or more to 10% or less, since light with a level which is almost equal to that of the light reflected by the fiber grating 225 is input into the second photodetector 130 and then into the controller 310, the wavelength control can be performed with stability. The first and second specified ratios are more preferably respectively 92-99% to 8-1%, most preferably 93-97% to 7-3%.

Preferably, in the stable wavelength laser beam generating device according to the present invention, the fiber grating 225 is a reflective fiber grating, the second optical splitter 122 is provided with a first fiber input side port 122c for inputting the monitor signal and a second fiber input side port 122d for outputting signal light reflected by the reflective fiber grating as a monitor output, and the controller 310 receives reference light passing through the reflective fiber grating 225 and signal light output from the second fiber input side port 122d as a monitor output and feeds back a wavelength control signal for controlling the wavelength of the laser source 110 to the laser source 110 to stabilize the wavelength of the laser beam from the laser source 110 within a wavelength band used as a signal band.

Preferably, in the stable wavelength laser beam generating device according to the present invention, the fiber grating 225 is a passing through type fiber grating, the second optical splitter 122 is provided with a first fiber input side port 122c for inputting the monitor signal and a second fiber input side port 122d for outputting reference light reflected by the passing through type fiber grating 225 as a monitor output, and the controller 310 receives signal light passing through the passing through type fiber grating 225 and a reference light output from the second fiber input side port 122d as a monitor output and feeds back a wavelength control signal for controlling the wavelength of the laser source 110 to the laser source 110 to stabilize the wavelength of the laser beam from the laser source 110 within a wavelength band used as a signal band.

In the stable wavelength laser beam generating device, the controller 310 preferably receives an output value from a signal light detector which receives the signal light and an output value from a reference light detector which receives the reference light and executes the following calculation to normalize the wavelength of the signal light with respect to a wavelength band used as a signal band:

Γ=(PD1-PD2)/(PD1+PD2)

wherein Γ represents an index obtained by normalizing the wavelength of the signal light with respect to a wavelength band used as a signal band, PD1 represents an output value from the signal light detector, and PD2 represents an output value from the reference light detector. Then, it is possible to judge how accurate the wavelength of the signal light is with respect to the wavelength band used as a signal band easily.

In accomplishing the above objects, a wavelength stabilization module according to the invention comprises, as shown e.g. in FIG. 20, a fiber grating 521 having a refractive index change part provided in an optical fiber 511 having a core 511a of a specified refractive index and a cladding 511b of a refractive index which is lower than that of the core 511a and inclined with respect to the direction perpendicular to the optical axis AX of the optical fiber 511; a transparent member 531 formed on the outside of the core 511a of the fiber grating 521; and at least two photodetectors 501 and 502 provided on the outside of the transparent member 531 and arranged along the optical axis AX. The refractive index of the transparent member is typically almost equivalent to or higher than that of the cladding. The transparent member is formed of, for example, a transparent adhesive. The thickness of the transparent member is so determined that there is some distance between the cladding and the photodetectors.

Since the wavelength stabilization module comprises a fiber grating having a refractive index change part inclined with respect to the direction perpendicular to the optical axis AX of the optical fiber and a transparent member formed on the outside of the core of the fiber grating, part of signal light transmitted through the core can be reflected and extracted to the outside thereof. Also, since the wavelength stabilization module comprises at least two photodetectors provided on the outside of the transparent member and arranged along the optical axis, the quantity of light extracted to the outside can be detected.

The wavelength stabilization module may further comprise a controller 310 which compares outputs from the at least two photodetectors 501 and 502 to control the wavelength of light reflected by the fiber grating 521.

The wavelength stabilization module may comprise a plurality of fiber gratings 521 which reflect lights of different wavelength each other, arranged in series in the direction of the optical axis AX of the optical fiber 511 as shown e.g. in FIG. 25.

In accomplishing the above object, an optical communication system according to the invention comprises, as shown e.g. in FIG. 28, the above wavelength stabilization module 566, a plurality of laser modules 551 to 553; and an optical joiner 561 for bundling signal lights from the plurality of laser modules 551 to 553, and the plurality of fiber gratings are formed in an optical fiber on the output side of the optical joiner 561.

This application is based on the Patent Applications No. 2000-295928, 2001-086200 and 2001-275359 filed on Sep. 28, 2000, Mar. 23, 2001, and Sep. 11, 2001, respectively, in Japan, the contents of which are incorporated herein, as part thereof.

Also, the invention can be fully understood, referring to the following description in details. Further extensive application of the invention will be apparent from the following description in details. However, it should be noted that the detailed description and specific examples are preferred embodiments of the invention, only for the purpose of the description thereof. Because it is apparent for the person ordinary skilled in the art to modify and change in a variety of manners, within the scope and sprits of the invention. The applicant does not intend to dedicate any disclosed embodiments to the public, and to the extent any disclosed modifications or alternations may not literally fall within the scope of the claims, they are considered to be part of the invention under the doctrine of equivalents.

### BRIEF DESCRIPTION OF DRAWINGS

FIG. 1 is a flow diagram illustrating a wavelength stabilization module as a first embodiment of the invention and a stable wavelength laser beam generating device as a second embodiment of the invention;

FIG. 2 is a schematic cross-sectional view illustrating examples of a fiber grating for use in an embodiment of the invention;

FIG. 3 is a front view illustrating a method for producing an optical coupler for use in an embodiment of the invention;

FIG. 4 is a plan view of an optical coupler produced by the method shown in FIG. 3;

FIG. 5 is a cross-sectional view illustrating the manner in which light is transmitted through a core of an optical fiber and reflected light is transmitted through a cladding thereof;

FIG. 6 is a front view or a cross-sectional view of configurations for directing light from a fiber to the outside;

FIG. 7 is a graph showing the measurements of the relation between the intensity and the wavelength of light passing through a non-inclined FBG;

FIG. 8 is a graph showing the measurements of the relation between the intensity and the wavelength of light reflected by a non-inclined FBG;

FIG. 9 is a graph showing the measurements of the relation between the intensity and the wavelength of light passing through an inclined FBG;

FIG. 10 is a graph showing the measurements of the relation between the intensity and the wavelength of light reflected by an inclined FBG;

FIG. 11 is a graph showing the measurements of the relation between the total light quantity obtained by combining the data for FIG. 9 and FIG. 10 and the wavelength;

FIG. 12 is a flow diagram of a measuring device for obtaining the data for FIG. 7 to FIG. 11;

FIG. 13 is a flow diagram illustrating an example of an operating unit;

FIG. 14 is a structural view illustrating a wavelength stabilization module as a third embodiment of the invention and a stable wavelength laser beam generating device, having the wavelength stabilization module, as a fourth embodiment of the invention;

FIG. 15 is an explanatory view of the conversion characteristics of a signal PD module and a reference PD module for use in an embodiment of the invention;

FIG. 16 is an explanatory view of the conversion characteristic of an operating unit for use in an embodiment of the invention;

FIG. 17 is a structural view of a wavelength stabilization module used for wavelength control in a comparative example;

FIG. 18 is an explanatory view of the conversion characteristics of a signal PD module and a reference PD module for use in the comparative example;

FIG. 19 is an explanatory view of the conversion characteristic of an operational unit for use in the comparative example;

FIG. 20 is a schematic cross-sectional view illustrating fiber gratings for a wavelength stabilization module as an embodiment of the invention;

FIG. 21 is a flowchart illustrating the principle of a wavelength stabilization module as a fifth embodiment of the invention;

FIG. 22 is a schematic cross-sectional view of the configuration of a fiber grating for a wavelength stabilization module as an embodiment of the invention and around it;

FIG. 23 is a plan view of photodetectors for receiving light reflected by the fiber grating shown in FIG. 22 as seen from the side of the light receiving faces thereof;

FIG. 24 is a schematic cross-sectional view for further explaining the fiber grating shown in FIG. 22 in detail;

FIG. 25 is a schematic cross-sectional view illustrating the configurations of fiber gratings for a wavelength stabilization module as an embodiment of the invention and around it;

FIG. 26 is a schematic cross-sectional view illustrating the configuration of a fiber grating for a wavelength stabilization module as an embodiment of the invention and around it;

FIG. 27 is a plan view illustrating examples of a photodetector for use in an embodiment of the invention;

FIG. 28 is a flowchart illustrating optical communication systems as sixth and seventh embodiments of the present invention; and

FIG. 29 is a flow diagram illustrating a conventional laser beam generating device.

### BEST MODE FOR CARRYING OUT THE INVENTION

Description will be hereinafter made of the embodiments the invention with reference to the drawings. The same or corresponding parts are denoted in all figures by the same or similar numerals, and an overlapping description will be omitted.

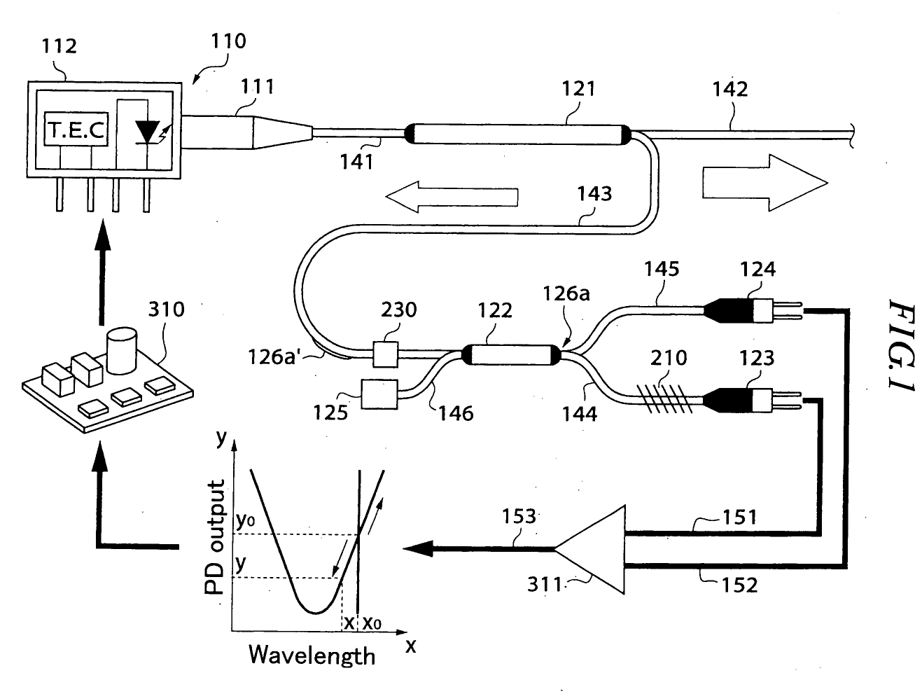

One embodiment of the invention will be described with reference to FIG. 1. As shown in FIG. 1, a laser source 110 comprises a laser diode 111 and a laser driving unit 112 as an energy supply unit for supplying energy to the laser diode and driving it.

The laser diode 111 has a laser output part to which an optical fiber (which will be hereinafter also referred to simply as “fiber”) 141 is connected. The fiber 141 is connected to an optical coupler 121 used as an optical splitter. Fibers 142 and 143 branch out of the optical coupler 121. The fiber 142 transmits a main signal and the fiber 143 extracts part of the main signal as a monitor signal.

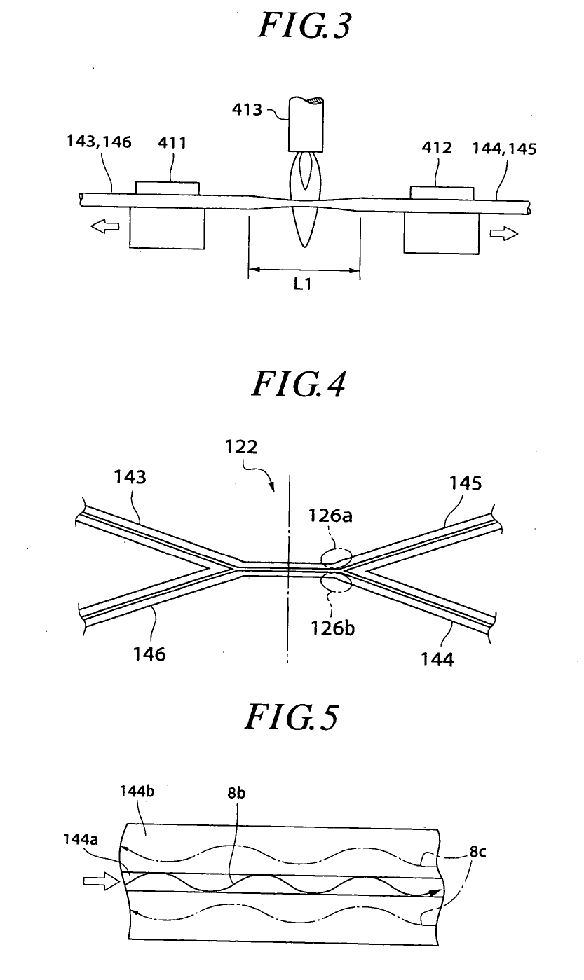

The fiber 143 is connected to an optical coupler 122 used as an optical splitter. Fibers 144 and 145 branch out of the optical coupler 122. The optical coupler 122, which will be hereinafter described in detail with reference to FIG. 3 and FIG. 4, has a fused region where two fibers are fused and configured to function as an optical coupler. As a result of the fusion of two fibers, four fibers 143, 144, 145 and 146 extend out of the optical coupler. Tapers are formed in the vicinity of the branching point of the fibers 144 and 145, namely the fused region. An adhesive having a refractive index which is almost the same as that of the core material of the fibers is provided at the taper portions as a high-refractive index material layer provided on the cladding layer thereof.

An isolator 230 is interposed in the fiber 143. An adhesive 126a′ having a refractive index which is higher than that of the cladding of the fibers is bonded on the outer side of a bent portion of the fiber 143 as an equivalent of a high-refractive index material layer of the invention provided on the cladding layer thereof.

The fiber 146 as the other port on the side of the optical coupler 122 opposite from the fibers 144 and 145 is connected to a photo diode (PD) module 125 for monitoring reflected light.

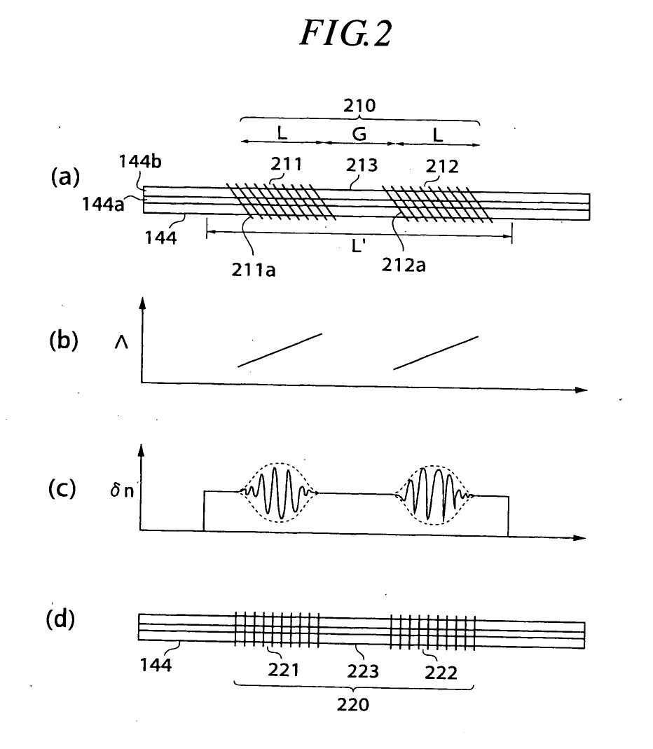

A photo diode (PD) module 123 as a photodetector is connected to the fiber 144. An FBG 210 is incorporated in the fiber 144 between the optical coupler 122 and the PD module 123. The FBG 210 is a diffraction grating in which the refractive index varies periodically along its length. The FBG 210 is an aggregation of refractive index change parts having a certain thickness. The refractive index change parts are arranged inclined, not perpendicular, to the optical axis of the fiber and parallel to each other. The FBG 210 will be hereinafter described in detail with reference to FIG. 2.

A PD module 124 for reference light is connected to the fiber 145.

The PD modules 123 and 124 are modules for converting a light signal to an electric signal, and connected to electric cables 151 and 152, respectively. The electric cables are connected to a light quantity change operating unit 311. The operating unit 311 includes a subtracter 312 (see FIG. 13) and detects an increase or decrease in a variable transmitted by a signal from the PD module 123 using a variable transmitted by a signal from the PD module 124 as a reference quantity. The thus detected increase or decrease in a variable to be adjusted with respect to the reference quantity is sent to a controller 310 through an electric cable 153 connected to the output side of the operating unit 311. The controller 310 is electrically connected to the laser driving unit 112. The operating unit 311 may be a micro computer which converts a signal to a digital signal and digitally operates the converted signal or an analogue operating element which operates the change in light quantity as an analogue signal.

In the above device, a wavelength stabilization module as a first embodiment includes the optical coupler 122, the PD modules 123 and 124, the FBG 210 and the operating unit 311, and a stable wavelength laser beam generating device as a second embodiment includes the wavelength stabilization module, the laser source 110 and the controller 310.

The operation of the wavelength stabilization module and the stable wavelength laser beam generating device constituted as above will be described with reference to FIG. 1. A laser beam emitted from the laser diode 111 reaches, through the core of the fiber 141, the optical coupler 121, from which a main signal is supplied to an optical communication system such as a wavelength-division multiplexing transmission system (WDM) through the fiber 142. Part of the main signal is extracted into the fiber 143 as a monitor signal by the optical coupler 121 and sent to the optical coupler 122, where the monitor signal is divided into two signals, which are in turn sent to the PD modules 123 and 124 through the fibers 144 and 145, respectively. The signal sent to the fiber 144 reaches the FBG 210, where light of a specific wavelength is passing and sent to the PD module 123 and light of the other wavelengths is reflected and returned toward the optical coupler 122 through the fiber 144.

Since the refractive index change parts of the FBG 210 are inclined, a considerable part of the reflected light escapes from the fiber 144 to the outside. Also, a considerable quantity of light is directed to the outside of the fiber by the adhesive bonded on the taper parts in the vicinity of the fused region of the optical coupler. Additionally, light escapes from the isolator 230 and the adhesive layer 126a′. Thus, only a small quantity of the reflected light returns to the laser source 110. Thereby, according to this embodiment, the effect of the light reflected by the FBG 210 to the laser source 110 can be made so small that it can be almost ignored. The reflected light returned to the laser source is preferably not greater than −35 dB, and this level can be accomplished with the embodiment.

Although the configuration for directing light from the fiber to the outside, namely the means for removing reflected light has been described as comprising the inclined FBG 210, the adhesive layer 126a, the isolator 230 and the adhesive layer 126a′, at least one of them is enough, or two or three of them may be combined. When the inclined FBG 210 is not used, a non-inclined FBG 220 (see FIG. 2(d)) is combined with the other configurations for directing light to the outside.

A PD module 125 is provided to monitor the reflected light returned through the optical coupler 122. The PD module 125 may be provided for experimental use and used to check the performance of the device, or may be provided in a device for practical use to monitor the performance of the device when necessary. The isolator 230 and the adhesive layer 126a′ are not necessarily provided on the fiber 143 but may be provided on any fiber between the FBG 210 and the laser diode 111.

FIG. 2(a) is a schematic cross-sectional side view of the FBG 210, taken along the length thereof. The FBG 210 is incorporated in the fiber 144 as a part thereof produced by stretching a core 144a having a relatively high refractive index and a cladding 144b surrounding the core 144a and having a refractive index which is lower than that of the core 144a.

The FBG 210 has a refractive index change part 211 as a first diffraction grating in which the refractive index varies periodically along its length. As described before, the refractive index change part 211 can be regarded as an aggregation of individual refractive index change parts 211a. A plurality of the refractive index change parts 211a are arranged parallel to each other in layers. The refractive index change part 211 has a length L. A refractive index change part 212 as a second diffraction grating in which the refractive index varies periodically along its length is provided at a point a distance G from the first diffraction grating. The refractive index change part 212 can also be regarded as an aggregation of a group of refractive index change parts 212a. The refractive index change part 212 also has a length L. In a section 213 corresponding to the distance G, the refractive index is constant along its length. This section is also referred to as a flat part 213 since the refractive index is not varied but constant therein.

In the FBG 210, the section with a length L′ including the first refractive index change part 211, the flat part 213 and the second refractive index change part 212 is processed to have a refractive index which is one level higher than the fiber parts upstream and downstream thereof as shown in FIG. 2(c).

The FBG 210 herein is a portion with a length of 2L+G including the first refractive index change part 211 (length: L), the flat part 213 (length: G) and the second refractive index change part 212 (length: L). The FBG 210, which should include at least the above three sections, may include fiber parts upstream and downstream thereof. For example, the FBG 210 may be a portion with a length of L′ in FIG. 2 or a portion with a certain length including the portion of the length of L′ and a length of portions of the fibers 144 upstream and downstream thereof.

Although the FBG 210 may be connected to the optical fiber 144 with an optical coupler, it is preferred that the FBG 210 be incorporated in the optical fiber 144 as a part thereof.

FIG. 2(b) is a graph showing the state in which the period Λ of change in the refractive index is gradually changed in the first and second refractive index change parts 211 and 212 along their length. As illustrated, the period of change in the refractive index of the first and second refractive index change parts 211 and 212 is gradually changed from the left side end to the right side end thereof. Namely, each of the first and second refractive index change parts 211 and 212 constitutes a chirped grating, as it is called. In the FBG 210, the period of change in the refractive index gradually increases.

In such a FBG, as the intervals of the period of the change in the refractive index is closer to equal, namely as the gradient of the chirp is lower, the bandwidth of light which is reflected thereby (or allowed to pass therethrough) is narrower, and as the gradient of the chirp is greater, the bandwidth of light which is reflected thereby is wider.

FIG. 2(c) is a graph showing the change δn in refractive index n along the length of the fiber. In the FBG 210, the refractive index of the first refractive index change part 211 is apodized. Namely, the envelope connecting the peaks of amplitude of change in the refractive index which periodically varies increases monotonously from amplitude 0 to the local maximum amplitude and then monotonously decreases to 0 in the direction in which the light is guided. In other words, the amplitude of change in the refractive index increases gradually from 0 from the left end toward the right in the graph, reaches the local maximum at the midpoint between the left end and the right end, and decreases to 0 to the right end. As described above, the amplitude of change in the refractive index is 0 at the starting point (left end in the drawing) and the ending point (right end in the drawing) and maximum at the center, and varies symmetrically right and left.

The refractive index of the second refractive index change part 212 is apodized in exactly the same manner. In the FBG 210, the period of change in the refractive index (distance or interval between peaks of the change in the refractive index), the degree of increase in the period of change in the refractive index (distance between peaks) and the change in amplitude of the refractive index of the second refractive index change part 212 are generally the same as those of the first refractive index change part 211.

When two chirped gratings apodized as above are provided in series, the starting point and the ending point of each diffraction grating region become vague. There is no effective resonator having the starting point and the ending point as terminals, so that each of the chirped gratings functions as an etalon having a single resonator length of L+G. Thus, it is possible to obtain a transmission characteristic curve having transmission peaks with equal intervals and a simple amplitude distribution like a Gaussian curve.

Thus, in the FBG 210 of this embodiment, the period of the transmission peaks can be controlled by the sum of the length L of the diffraction grating and the distance G between the diffraction gratings (L+G).

To produce the FBG 210, a material whose refractive index changes e.g. by irradiation of ultraviolet ray such as a material containing Ge is used for the core 144a of the optical fiber. With a material containing GeO₂ in particular, parts exposed to ultraviolet ray have a higher refractive index than parts not exposed.

Then, a diffraction pattern is transferred onto the optical fiber by a phase mask method. In a phase mask method, light is irradiated on an optical fiber from a side through a mask having slots corresponding to the period of change in refractive index.

At this time, when a phase mask in which the period of the slots gradually becomes longer is used, the period of change in refractive index can be gradually changed, for example, increased.

In addition, when the slots of the phase mask are not perpendicular to the longitudinal direction of the fiber but inclined with respect to the direction perpendicular to the longitudinal direction, the refractive index change parts can be inclined with respect to the direction perpendicular to the optical axis of the fiber 144 (central axis of the core 144a). The angle of the FBG is determined taking reflection and polarization dispersion loss into consideration since too large an inclination angle increases polarization dispersion loss.

The apodization can also be realized by irradiating the right and left end parts of the fiber in the drawing with a smaller quantity of processing light than the middle part thereof. As has been described above, in the FBG 210, a transmission characteristic curve having peaks with equal intervals as that of a Fabry-Perot etalon can be realized with one seamless fiber. Thus, the FBG 210 exhibits stable characteristics against environmental disturbance such as temperature change or impacts can be obtained, and can be used as a frequency reference or for stabilization of wavelength in wavelength multiplex communication.

Also, it is possible to realize an FBG having a transmission characteristic curve having peaks with equal intervals, which can be used for stabilization of the wavelength of a light source or as a frequency reference for a measuring instrument in wavelength multiplex communication, in a fiber.

In the FBG 210 for use in the embodiment of the invention, since a regular waveform is formed, the gradients of each wavelength can be calculated and correction coefficients for each wavelength are apparent. Thus, even a small deviation in wavelength can be easily detected and corrected. Thus, when the FBG 210 is used, the wavelength interval of a laser beam from each oscillation light source can be fixed to a constant value, namely locked, and a stable optical communication system can be realized.

Also, since a regular waveform is formed, the FBG 210 exhibits excellent S/N characteristics when used as a filter.

FIG. 2(d) shows an FBG 220 having refractive index change parts arranged perpendicular to the optical axis of the fiber 144. The FBG 220 comprises a first diffraction grating 221, a second diffraction grating 222 and a flat part 223 provided between the first and second diffraction gratings 221 and 222. The FBG 220 has the same structure as the FBG 210 except that the refractive index change parts in the first and second diffraction gratings 221 and 222 are not inclined but perpendicular to the optical axis of the fiber 144. The FBG 220 cannot direct reflected light to the outside in contrast to the FBG 210, but can be used in conjunction with other means for directing light to the outside as one embodiment.

One example of the method for producing the optical coupler 122 will be described with reference to FIG. 3. A fiber for forming the fibers 143 and 144 and a fiber for forming the fibers 146 and 145 are crossed and clamped with clamps 411 and 412. When the clamps 411 and 412 are moved farther apart from each other while the point where the two fibers cross is heated with a burner 413, the two fibers are fused in the heated region and the cores are integrated with each other. When the diameter of the core of the fiber 144 is 8-10 μm, for example, the diameter of the core of the fused region of the optical coupler becomes slightly smaller, 6-8 μm, for example.

FIG. 4 is a view of the thus produced optical coupler 122 as seen from a position where all the four fibers branching out therefrom can be seen. As illustrated, the fibers 144 and 145 have tapers toward the fused region. Adhesives 126a and 126b are provided on the taper portions and cured. Preferably, the adhesives are provided on the outer side of the Y-shaped fused region. The adhesives 126a and 126b may be applied thinly or in a mass. The outer surfaces of the adhesives 126a and 126b may be subjected to light scattering treatment or frosted so that light may be scattered thereat. The adhesives 126a and 126b have a refractive index which is almost the same as that of the core 144a and at least higher than that of the cladding 144b. Thus, reflected light returned through the fibers 144 and 145 escapes to the outside through the adhesives 126a and 126b.

Since the adhesives 126a and 126b are provided on the taper portions, light transmitted from the fiber 143 side and into the fiber 144 or 145 through the optical coupler 122 can hardly escape to the outside of the fiber. However, returned light enters the adhesives 126a or 126b at a large incident angle and is directed to the outside of the fiber. The adhesive 126a and 126b, which are separately provided in the drawing, may be integrally provided on the taper portions.

FIG. 5 schematically illustrates the manner in which lights are transmitted through an optical fiber, taking the fiber 144 as an example. Since the core 144a has a refractive index which is higher than that of the cladding 144b, light 8b transmitted through the core 144a, which is completely reflected at the interface between the core 144a and the cladding 144b and cannot escape into the cladding 144b, is gathered at the center of the core 144a. Thus, transmitted lights are gathered at the center of the core 144a.

However, light 8c, which is part of light reflected by the FBG 210, is returned through the cladding 144b. Since the adhesives 126a and 126b having a high refractive index are provided on the outside of the cladding 144b, especially on the taper portions and the outer side of a bent portion of the fiber, the light 8c enters the boundary between the adhesive and the cladding and directed to the adhesive having a high refractive index. The same phenomenon occurs in the adhesive layer 126a′ shown in FIG. 1. Since the inner side of the cladding 144b is in contact with the core 144a having a high refractive index, part of the light 8c is directed to and enters the core 144a. To prevent that from happening, the adhesives 126a and 126b having a high refractive index are preferably provided in the vicinity of the FBG 210.

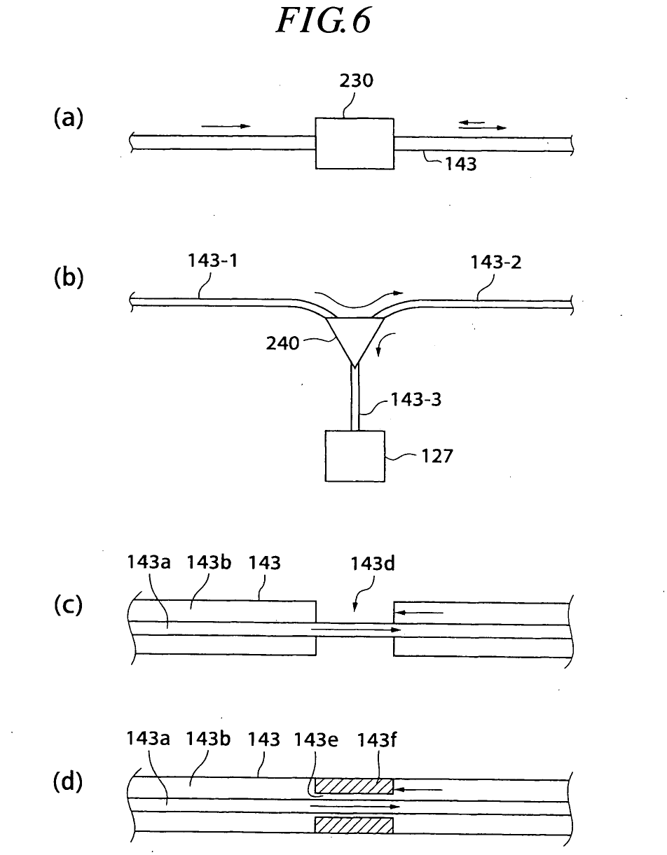

Description will be made of other examples of the configuration for directing light to the outside of the fiber with reference to a schematic explanatory view of FIG. 6. FIG. 6(a) illustrates an isolator 230 interposed in the fiber 143. The isolator 143, which is herein schematically illustrated as a rectangle, includes a YIG crystal and a polarizing filter provided upstream (on the light source side) of the YIG crystal. Light enters into the isolator 230 from one side thereof is polarized by the polarizing filter, and its polarization direction is rotated by 45° by the YIG crystal. The polarization direction of light reflected by the FBG 210 and returned to the isolator 210 is rotated by another 45° by the YIG crystal while it passes therethrough. As a result, the polarization direction of the light is rotated through 90° in total with respect to the polarization direction of the polarizing filter. Thus, the reflected light is filtered out by the polarizing filter.

A configuration hereinbelow described may be adopted instead of or in conjunction with the isolator 230 shown in FIG. 1.

FIG. 6(b) shows a circulator 240 interposed in the fiber 143. Three fibers 143-1, 143-2 and 143-3 are connected to the circulator 240. Light which enters from the fiber 143-1 exits to the fiber 143-2. Light reflected by the FBG 210 provided downstream of the fiber 143-2 is directed to the fiber 143-3 by the circulator 240 and thus is not returned to the fiber 143-1. A PD module 127 is provided at the end of the fiber 143-3, so that the quantity of the reflected light can be monitored. A light absorbing part may be provided as the terminal instead of the PD module 127.

FIG. 6(c) shows a cladding-removed section 143d a part of the cladding 143b, as reflected light removing means. In this section, the cladding 143b is removed from the whole circumference of the core 143a. Although light transmitted through the core 143a can pass through this section, light returned through the cladding 143b exits to the outside from an end face of the cladding-removed section 143d. The end faces of the cladding-removed section 143d are preferably frosted so that light may be scattered at the end faces.

FIG. 6(d) shows a configuration in which a high-refractive index material 143f is filled in the cladding-removed section 143d. The high-refractive index material 143f has a refractive index which is higher than that of the cladding layer 143b, preferably equivalent to that of the core 143a. An adhesive may be used as in the case with the adhesive layers 126a, 126b and 126a′. In this case, however, the cladding layer around the core 143a is not completely removed but a thin cladding layer 143e is left around the core 143a. Thereby, only reflected light returned through the cladding layer 143b can be removed without directing light to be transmitted through the core 143a to the high-refractive index material 143f.

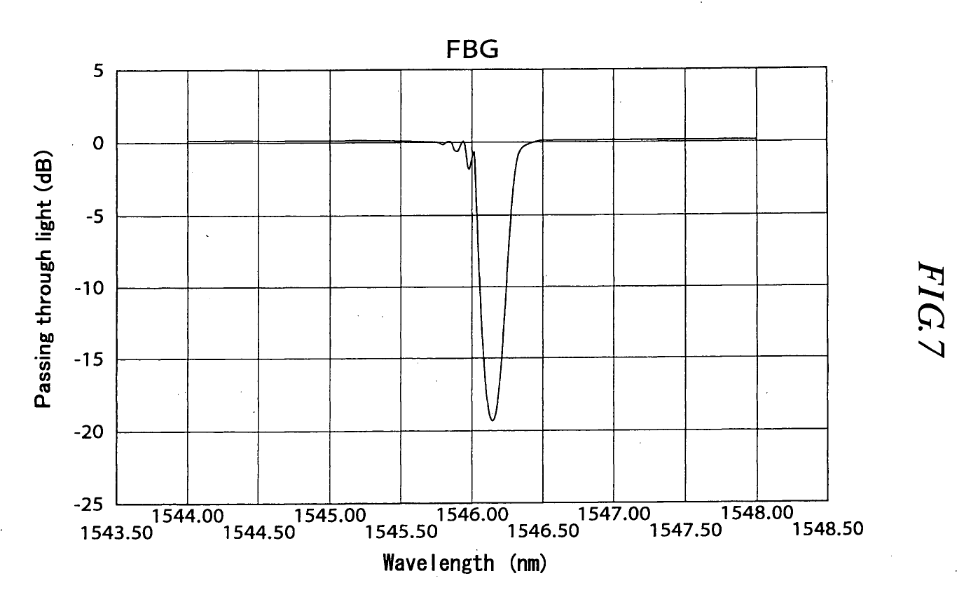

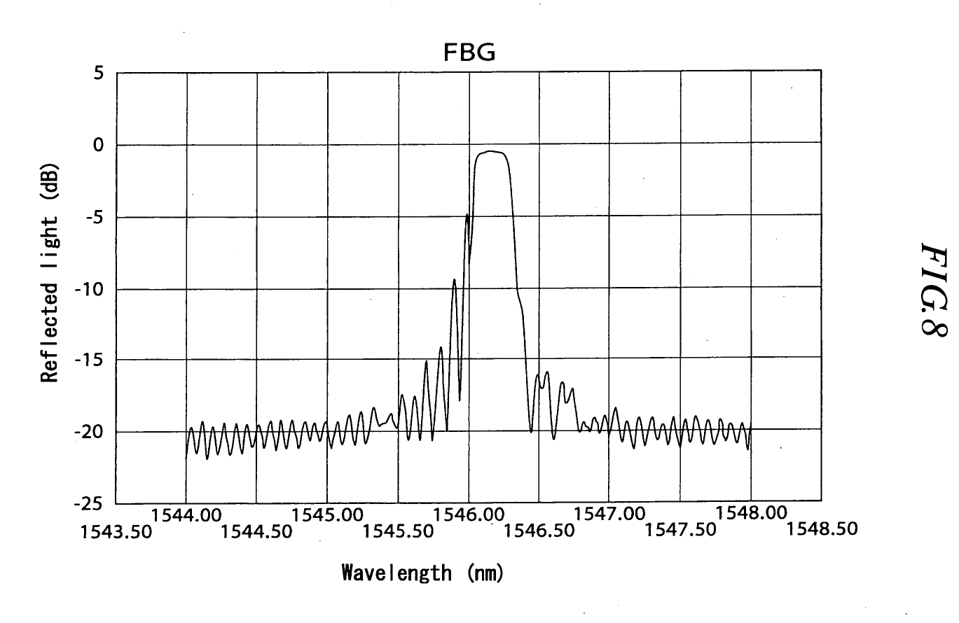

Description will be made of one example of the relation between the wavelength and the quantity of light passing through the FBG 210 with reference to the graph in FIG. 7. The graph clearly indicates that the FBG reflects light of wavelength around 1546.20 nm and pass light of the other wavelengths almost entirely.

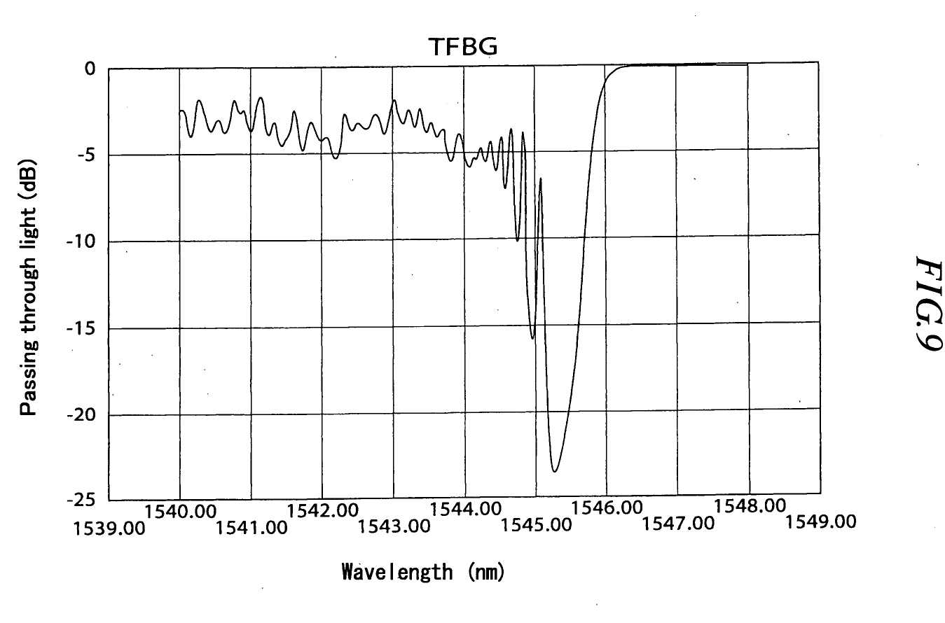

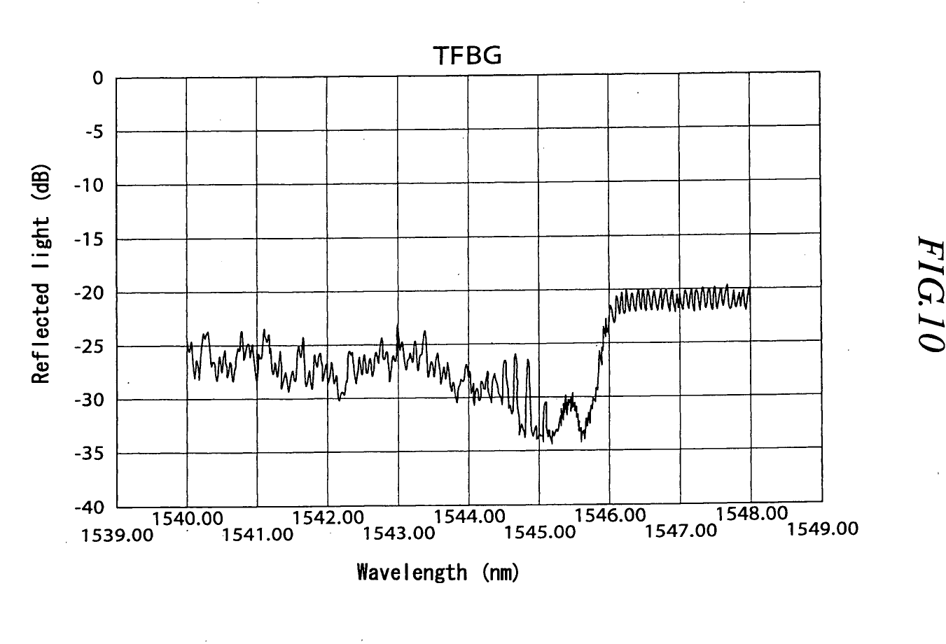

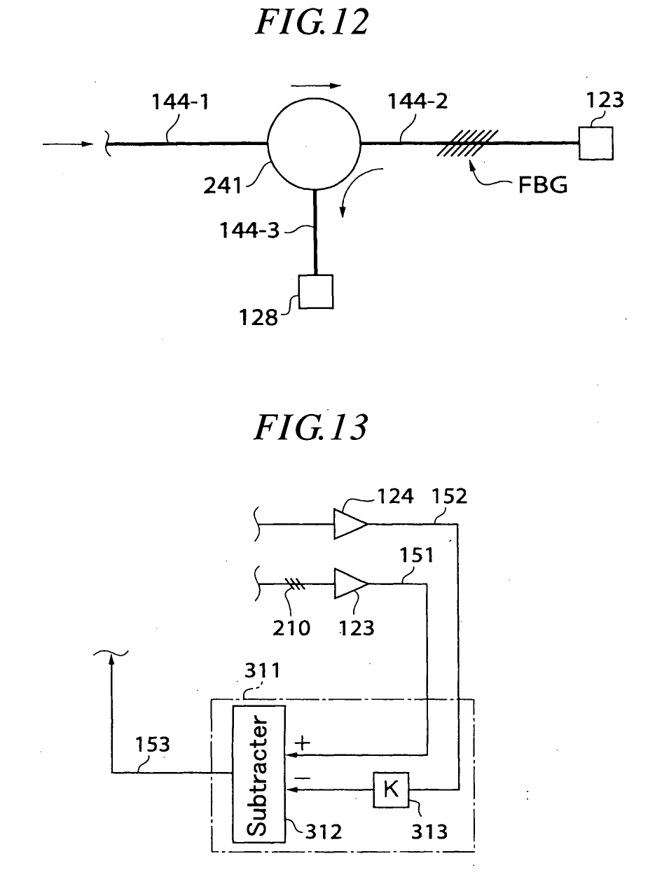

Description will be made of the state of reflected light from an FBG with reference to FIG. 7 and FIG. 8, which are graphs showing the characteristics of the non-inclined (perpendicular to the optical axis) FBG 220, and FIG. 9 to FIG. 11, which are graphs showing the characteristics of the inclined (not perpendicular to the optical axis) FBG 210. In this experiment, a device as shown in the flow diagram in FIG. 12 is used. As shown in FIG. 12, to a circulator 241 are connected a fiber 144-1 for directing light to the circulator 241, a fiber 144-2 for directing a light from the circulator to a PD module 123 through an FBG, and a fiber 144-3 for directing a light returned through the fiber 144-2 to a PD module 128.

Light from the fiber 144-1 was directed to the fiber 144-2 through the circulator 241, transmitted through the FBG and reaches the PD module 123, where the light quantity of the transmitted light was measured. Part of the light was reflected by the FBG and directed to the fiber 144-3 through the circulator 241. The light quantity of the reflected light was measured by the PD module 128. As a result of measurement of the PDL simultaneously conducted, the angle of 2 to 6° was considered to be preferable, and the inclined FBG 210 alone was used as the configuration for directing light to the outside in this experiment. The inclination angle of the inclined FBG was set to 5° with respect to a direction perpendicular to the optical axis of the core.

The graph showing the relation between the wavelength and the light quantity of transmitted light in FIG. 7 and the graph showing the relation between the wavelength and the light quantity of reflected light in FIG. 8 clearly indicate that the FBG 220 transmits light almost entirely except light of wavelength around 1546.20 nm and reflects light of wavelength around 1546.20 nm.

The graph showing the relation between the wavelength and the light quantity of transmitted light in FIG. 9 clearly indicates that the FBG 210 transmits light of wavelength of more then 1546.20 nm almost entirely. The graph showing the relation between the wavelength and the light quantity of reflected light in FIG. 10 clearly indicates that the level of the reflected light is lowered.

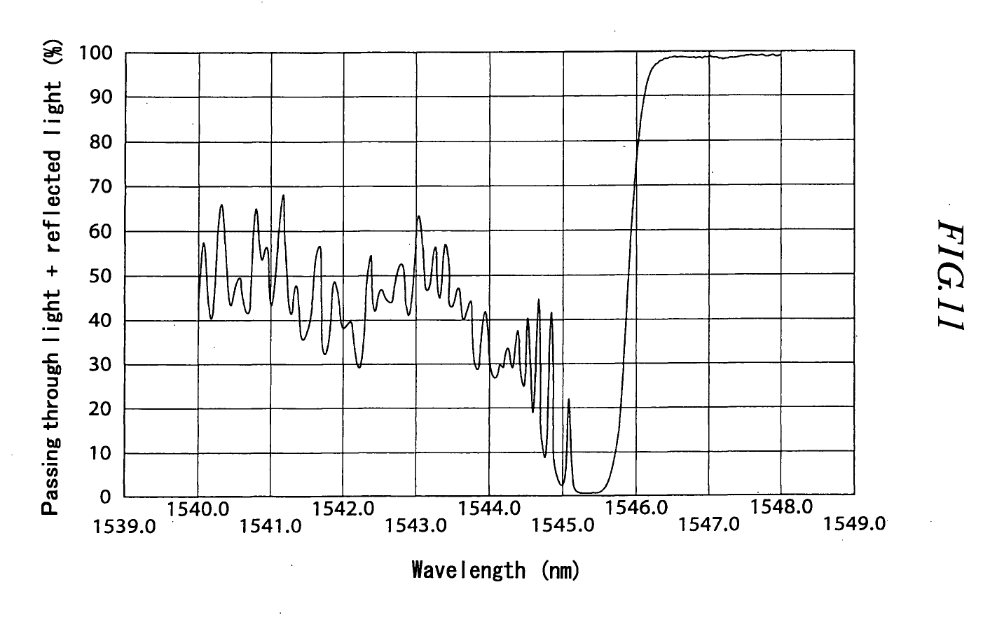

FIG. 11 is a graph showing the results obtained by combining data for FIG. 9 and FIG. 10 on percentage basis. When the energy of the transmitted light and the reflected light is preserved, the total light quantity must be almost 100% in every wavelength region. However, the graph clearly indicates that the energy is reduced in the wavelength region of 1546.0 nm or less. This means the reflected light is emitted from a light directing element of the optical fiber because absorption of light is unthinkable in an optical fiber.

Description will be made of one example of a wavelength stabilization module with reference to the flow diagram in FIG. 13, and to FIG. 1 as necessary. An electric signal sent from a PD module 123 through an electric cable 151 is directed to a subtracter 312. An electric signal sent from a PD module 124 through an electric cable 152 is gain-adjusted in a gain adjuster 313 and then directed to the subtracter 312 as a reference signal. The result of subtraction is provided to a control 310 through an electric cable 153 as feedback.

The controller 310 controls the wavelength of a laser beam emitted by the laser source 110 so that the directed signal may be zero. The wavelength of the laser beam is controlled using, for example, a Peltier current controller and a Peltier element for controlling the temperature of the laser diode 111. A Peltier element can heat or cool the laser diode 111 using a current signal. The wavelength can be set to a specified value by determining a gain K given in the gain adjuster 313. Namely, as shown in a wavelength/PD output curve (x-y curve) in FIG. 1, the quantity of light transmitting through the FBG 210 has a gradient according to its characteristics.

Assume that the wavelength to be locked as the wavelength of the main signal is X₀ and the PD output corresponding to X₀ on the characteristic curve is y₀, and that the PD output of light transmitted through the FBG 210 at some point in time is y and the output corresponding to y is x. A gain K is given to a signal from the PD module 124 to set the output to y₀. When there is a difference between y and y₀, the output y-y₀ of the subtracter 312 does not become zero. The controller 310 controls the wavelength of light emitted from the laser source 110 so that the difference may be zero. Thereby, the wavelength stabilization module can control the wavelength of light, and the laser beam generating device can stably generate a laser beam of a desired wavelength. Also, since reference light from the PD module 124 is used, even when the intensity of the laser beam generated by the laser diode (LD) 111 is slightly varied, the variation can be compensated.

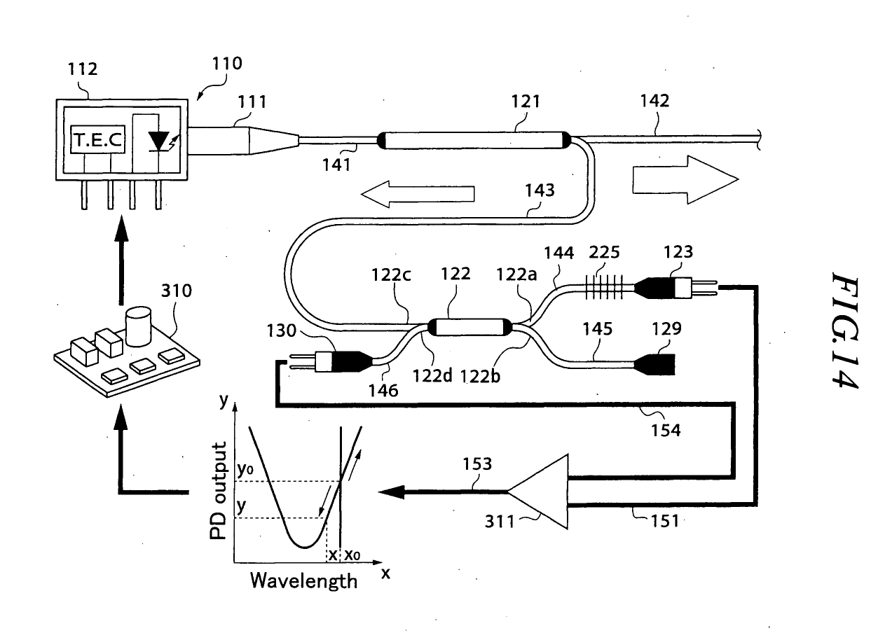

FIG. 14 is a structural view illustrating a wavelength stabilization module as a third embodiment of the invention and a stable wavelength laser beam generating device including the wavelength stabilization module.

As shown in FIG. 14, the device is provided with a light source 110, a laser diode 111 and a laser driving unit 112 as an energy supply device as in the case with the device in FIG. 1. Description of configurations in common with the device in FIG. 1 will be omitted as much as possible.

An optical coupler 121 used as a first optical splitter is connected to the fiber 141. Fibers 142 and 143 branch out of the optical coupler 121. The fiber 142 transmits a main signal and the fiber 143 extracts part of the main signal as a monitor signal. The optical coupler 121 splits light at a first specified splitting ratio. One example of the first specified ratio is as follows:

(main signal to fiber 142):(monitor signal to fiber 143)=95:5 (1)

An optical coupler 122 used as a second optical splitter is also connected to the fiber 143. The optical coupler 122 has a first fiber side output port 122a of which a fiber 144 extends out and a second fiber output side port 122b of which a fiber 145 extends out. The optical coupler 122 splits light into an FBG input signal to the fiber 144 and a termination signal to the fiber 145 at a second specified splitting ratio. One example of the second specified splitting ratio is as follows:

(FBG input signal to fiber 144):(termination signal to fiber 145)=5:95 (2)

A PD (photo diode) module 123 as a photodetector is connected to the fiber 144. A fiber Bragg grating (FBG) 225 is incorporated in the fiber 144 between the optical coupler 122 and the PD module 123. The FBG 225 is a diffraction grating in which the refractive index varies periodically along its length. There are two types of fiber Bragg gratings; reflective type and passing through type. Here, the FBG 225 is a reflective FBG. The fiber 145 is terminated, so that light directed to the fiber 145 is scattered and is not returned to the fiber 145. The terminal 129 may be terminated by connecting a terminal module to the end of the fiber or by simply damaging the fiber.

The optical coupler 122 has a first fiber input side port 122c to which the fiber 143 is connected and a second fiber input side port 122d for outputting signal light from the fiber 144 reflected by the fiber grating 225 as a monitor output. Although the fiber input side ports 122c and 122d are referred to as “port”, the optical fibers do not have to be ended at the ports. The optical fiber and the optical coupler 122 are continuously configured in reality. The fiber 146 has an end connected to the second fiber input side port 122d and the other end connected to a PD module 130 as a photodetector. The fibers 143 and 146 extend out of the fiber input side ports 122c and 122d, respectively, of the optical coupler 122. A band wavelength component to be used as signal light in an FBG input signal passing through the fiber 144 is reflected by the reflective fiber grating 225 and split into signal light to the fiber 146 and return light to the fiber 143. The splitting ratio is equivalent to the ratio of the equation (2):

(signal light to fiber 146):(return light to fiber 143)=95:5 (3)

The PD modules 123 and 130 are modules for converting a light signal into an electric signal, and are connected to electric cables 151 and 154, respectively. The electric cables are connected to an operating unit 311. The operating unit 311 includes a subtracter and detects an increase or decrease in a variable transmitted by a signal from the PD module 123 using a variable transmitted by a signal from the PD module 130 as a reference quantity. Here, the signal light to the fiber 146 includes 95% of the reflected component of an FBG input signal reflected by the reflective fiber grating 225, namely most of the signal band wavelengths of the FBG input signal, so that the light quantity level is almost balanced. Thus, operation can be executed stably in the operating unit 311 without large gain adjustment. The thus detected increase or decrease in a variable to be adjusted with respect to the reference quantity is sent to a controller 310 through an electric cable 153 connected to the output side of the operating unit 311. The controller 310 is electrically connected to the laser driving unit 112 as an energy supply unit.

In the above device, the wavelength stabilization module as the third embodiment includes the optical coupler 122, the PD modules 123 and 130, the FBG 225 and the operating unit (calculator) 311, and the stable wavelength laser beam generating device as the fourth embodiment includes the wavelength stabilization module, the light source 110 and the controller 310.

Description will be made of the operation of the wavelength stabilization module and the stable wavelength laser beam generating device constituted as above with reference to FIG. 14. As in the case with the device in FIG. 1, a laser beam emitted from the laser diode 111 reaches, through the core of the fiber 141, the optical coupler 121, from which a main signal is supplied to an optical communication system such as a wavelength-division multiplexing transmission system (WDM) through the fiber 142. Part of the main signal is extracted into the fiber 143 as a monitor signal by the optical coupler 121 and sent to the optical coupler 122, where the monitor signal is divided into two signals, which are in turn sent to the fiber grating 225 and the terminal 129 through fibers 144 and 145, respectively. The FBG input signal sent to the fiber 144 reaches the fiber grating 225, where light of a specific wavelength is reflected as signal light and sent to the PD module 130 through the fiber 144, the optical coupler 122 and the fiber 146. Light of the other wavelengths are passing through the fiber grating 225 and sent to the PD module 123 as reference light. The signal sent to the fiber 145 is terminated at the terminal 129, so that there is no signal returned to the optical coupler 122.

The light returned to the fiber 143 is reduced by the optical coupler 122 to about 5% of the FBG input signal passing through the fiber 144 reflected by the fiber grating 225, and the return light returned through the fiber 143 is further reduced to 5% by the optical coupler 121 before entering the fiber 141. Thus, only a small quantity of light can be returned from fiber 143 to the light source 110 through the optical coupler 121. Therefore, according to this embodiment, the effect on the light source 110 of light reflected by the FBG 225 and returned through the fiber 143 can be made so small as to be almost ignored. The reflected light returned to the light source is preferably not greater than −35 dB, more preferably not greater than −40 dB. In this embodiment, the reflected light passing through the optical couplers 121 and 122, the FBG 225, and the optical couplers 121 and 122, the total attenuation is 13 (fiber 141 to fiber 143)+13 (fiber 143 to fiber 144)+3 (fiber 144 to fiber 144 through fiber grating 225)+13 (fiber 144 to fiber 143)+13 (fiber 143 to fiber 141)=55 dB. Thus, the desired level is achieved.

Description will be next made of the control of laser beam wavelength. An electric signal sent from the PD module 123 through the electric cable 151 is directed into the subtracter 311 (see FIG. 13) in the operating unit 311. An electric signal sent from a PD module 130 through an electric cable 154 is gain-adjusted in a gain adjuster (see FIG. 13) in the operating unit 311 and then directed to the subtracter in the operating unit 311 as a reference signal. The result of subtraction is provided to a controller 310 through an electric cable 153 as feedback.

The method for controlling the wavelength of the laser beam in the controller 310 has been described in the description of the first and second embodiments with reference to FIG. 1 and FIG. 13, so its description is omitted here.

The controller 310 uses signal light from the PD module 130. The signal light is a reflection of a laser beam generated by a laser diode (LD) 111 reflected by the reflective fiber grating, and thus directly reflects the power of the laser beam. Thus, even when the power of the laser beam is slightly varied, control to stabilize the power can be easily performed by a feedback control with signal light from the PD module 130.

Although description has been made of the case in which the splitting ratio of the optical couplers 121, 122 at which incident light and reflected light are split is 95:5, the ratios may be 98:2 or 80:20 as long as the light quantity of return light returned to the light source 110 through the optical couplers 121, 122 and the PD module 123 is sufficiently attenuated with respect to an FBG input signal reflected by the fiber grating 225. The return light is preferably attenuated by at least 35 dB.

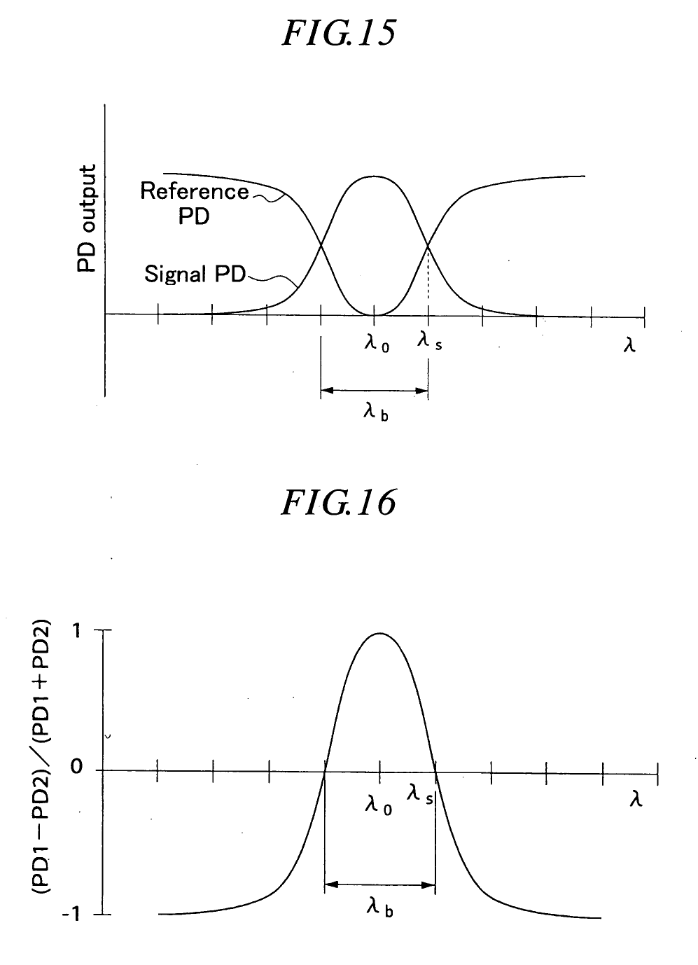

FIG. 15 is an explanatory view of the signal conversion characteristics of a signal PD module and a reference PD module, in which the horizontal axis represents the wavelength λ and the vertical axis represent the PD module output voltage. Here, description will be made taking a reflective fiber grating as an example, so that the PD module 130 corresponds to the signal PD module and the PD module 123 corresponds to the reference PD module. The signal conversion characteristic of the signal PD module has a pattern of the wavelength components which is reflected by the reflective fiber grating and exhibits a bell-shaped curve with a center wavelength of λ₀ and a half-band width of λb. The signal conversion characteristic of the reference PD module has a pattern of the wavelength components transmitted through the reflective fiber grating and exhibits a curve which is a mirror image of the curve of the signal PD module with respect to an output line in a wavelength range λ (in the range of 1530 to 1560 nm in case of a WDM). The wavelength λs is a wavelength fixed by the fiber grating 225.

FIG. 16 is an explanatory view of the operating characteristic of the operating unit 311, in which the horizontal axis represents the wavelength λ and the vertical axis represents the operated value. The operating unit 311 calculates an index Γ by normalizing the wavelength of real signal light with respect to a wavelength band allocated as a signal band according to the following equation.

Γ=(PD1−PD2)/(PD1+PD2) (4)

where PD1 represents a PD output value of the signal PD module and PD2 represents a PD output value of the reference PD module. The index Γ exhibits a bell-shaped curve with a center wavelength of λ₀ and a half-band width of λb, and takes a maximum value of +1 within the wavelength band used as the signal band (0.8 nm, for example). The index Γ takes negative values outside the wavelength band used as the signal band. The minimum value of the index Γ is −1. The optimum wavelength for signal light is a wavelength at a point at which the gradient of the index Γ in the direction of the wavelength λ is the largest. In the case of the FIG. 16, the wavelengths of λs and λs-λb at which the index Γ is 0 are preferred.

Referring again to the structural view in FIG. 4, description will be now made of the optical coupler 122 having four fibers branching out thereof. As illustrated, the fibers 144 and 145 have a Y-shaped fused region. However, the adhesives 122a and 122b in the FIG. 4 are not provided on the optical coupler used in this embodiment. The fibers 143 and 146 also have a Y-shaped fused region. The shape, for example, the diameter of each fiber is so determined that light is split toward each fiber at the splitting ratios of the equations (2) and (3).

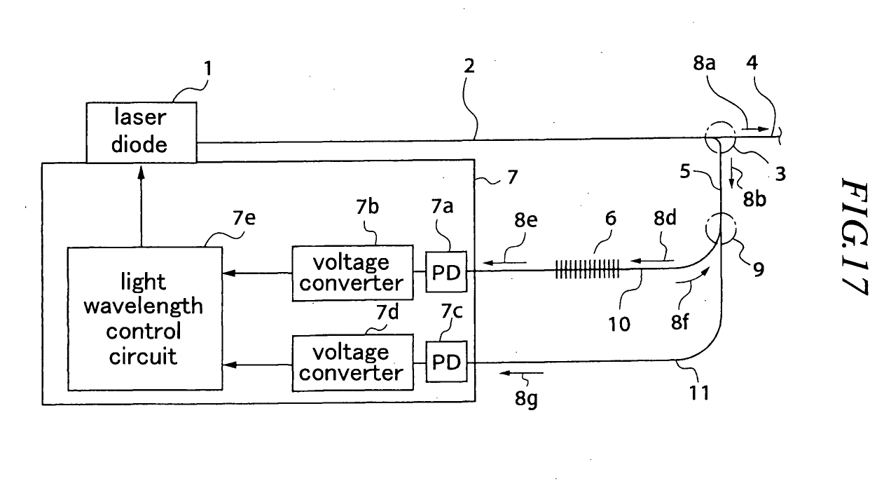

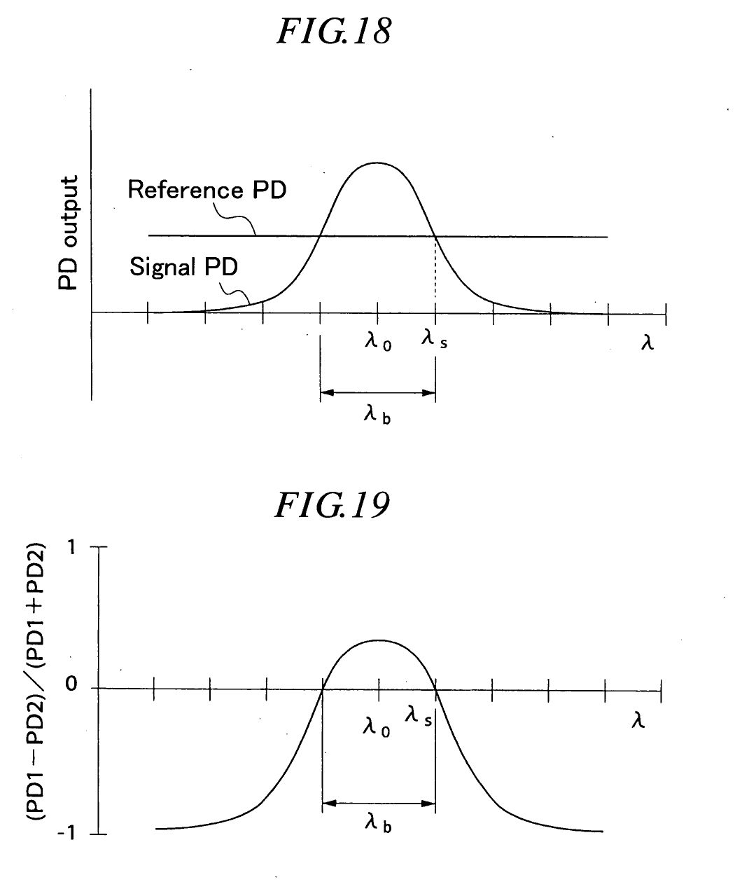

Referring to FIG. 17, FIG. 18 and FIG. 19, a comparative example of the stable wavelength laser beam generating device will be described. The comparative example uses a device shown in FIG. 17.

In general, in a wavelength-division multiplexing transmission system (WDM), as the wavelength density increases, the interval between adjacent wavelengths becomes smaller. A laser diode causes a drift of the center wavelength when its properties have changed with time or under some environmental conditions, resulting in crosstalk or interference with an adjacent wavelength. Thus, the temperature of the laser diode tip is controlled to keep the wavelength of the laser diode constant.

FIG. 17 is a structural view of a wavelength stabilization module of the comparative example used for wavelength control. As shown in FIG. 17, light from an optical device 1 including a laser diode is output through a fiber 2 and split to the fibers 4 and 5 by an optical splitter 3 at a specified splitting ratio (9:1, for example). A main signal 8a is sent through the fiber 4 and a monitor signal 8b is sent to an optical splitter 9. In the optical splitter 9, the monitor signal 8b is split into an FBG input signal 8c to be sent to a fiber 10 in which a fiber Bragg grating (FBG) 6 is provided and reference light 8g to be sent to a fiber 11.

When the FBG 6 is a passing through type FBG, only light of a specific wavelength is passing therethrough as signal light 8e and light of the other wavelengths is reflected as reflected light 8f. The signal light 8e passing through the FBG 6 is input into a wavelength control part 7 connected to the optical device 1, converted into an electric signal by a signal PD module 7a and sent to a voltage converter 7b. The reference light 8g transmitted through the fiber 11 is converted into an electric signal by a reference PD module 7c and sent to a voltage converter 7d. A light wavelength control circuit 7e outputs a control signal which decreases the difference between the signal corresponding to the signal light 8e output by the voltage converter 7b and the signal corresponding to the reference light 8g output by the voltage converter 7d. The control signal controls, for example, the temperature of the optical device 1 or electric power supplied to the optical device 1 to keep the wavelength of light generated by the optical device 1 constant.

In this device, the optical couplers 3 and 9 correspond to the optical couplers 121 and 122, respectively, of the device in FIG. 14, the signal PD module 7a of the device in FIG. 17 corresponds to the PD module 130 of the device in FIG. 14, and the reference PD module 7c of the device in FIG. 17 corresponds to the PD module 123 of the device in FIG. 14.

FIG. 18 is en explanatory view of the signal conversion characteristics of the signal PD module and the reference signal PD module, in which the horizontal axis represents the wavelength λ and the vertical axis represents the PD module output voltage. The conversion characteristic of the signal PD module 7a exhibits a bell-shaped curve with a center wavelength of λ₀ and a half-band width of λb because of the transmission characteristic of the fiber grating. The conversion characteristic of the reference PD module 7c is constant regardless of the wavelength λ since the reference light is not passing through a fiber grating.

FIG. 19 is an explanatory view of the operating characteristic of the operating unit 311, in which the horizontal axis represents the wavelength λ and the vertical axis represents the operated value. The operating unit 311 calculates an index Γ by normalizing the wavelength of real signal light with respect to a wavelength band allocated as a signal band according to the equation (4). The index Γ exhibits a bell-shaped curve with a center wavelength of λ₀ and a half-band width of λb. The index Γ takes positive values within a wavelength band used as a signal band (0.8 nm, for example) and negative values outside the wavelength band used as the signal band. The minimum value of the index Γ is −1. When comparison is made between the characteristic curve in FIG. 16 and the characteristic curve in FIG. 19, the maximum value of the index Γ is larger in the embodiment of the invention than in the comparative example. This means the embodiment of the invention has an acuter responsiveness.

Although description has been made of the signal light and the reference light taking a reflective fiber grating as an example, the invention is not limited thereto. A passing through type fiber grating may be also used. In the case of a passing through type fiber grating, the relation between the signal light and the reference light is inverse. Although PD (photodiode) modules are used as the photodetectors in the above embodiment, the invention is not limited thereto. Any module which generates an electric signal corresponding to an input light signal can be used.

The wavelength stabilization module according to the embodiment of the invention comprises a first optical splitter for splitting an input signal into a main signal and a monitor signal at a first specified splitting ratio, a second optical splitter for splitting the monitor signal into an FBG input signal and a terminal signal at a second specified splitting ratio, and a fiber grating formed in a fiber for transmitting the FBG input signal, and the first and second specified splitting ratios are so selected that light reflected by the fiber grating may be sufficiently attenuated with respect to the input signal in returning in the direction from which said input signal came through the second optical splitter and the first optical splitter. Thus, the quantity of light returned to the laser source can be restrained.

The stable wavelength laser generating device according the embodiment of the invention comprises the above wavelength stabilization module, a laser source for generating a laser beam to be supplied to the wavelength stabilization module, and a controller which receives light processed by the wavelength stabilization module and controls the wavelength of the laser beam which the laser source generates. Thus, the quantity of light returned to the laser source is small, and the wavelength of the laser beam can be easily controlled to be constant. When a normalization calculation is performed, which corresponds to the case shown in FIG. 15, the gradient of the index Γ becomes large as shown in FIG. 15. Thus, the responsiveness can be improved and the wavelength of the laser beam can be controlled to be constant.

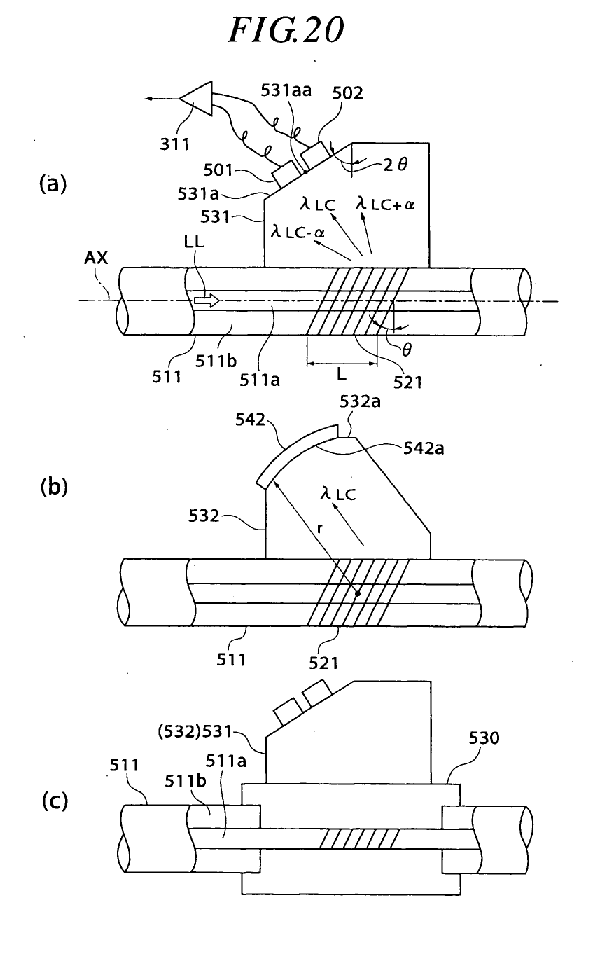

Description will be made of the configurations of the FBGs for use in the wavelength stabilization module as an embodiment of the invention and around it with reference to the schematic cross-sectional views in FIG. 20. As illustrated, in an optical fiber 511 comprising a core 511a having a specified refractive index and a cladding 511b having a refractive index which is lower than that of the core 511a, a plurality of refractive index change parts are provided inclined with respect to the direction perpendicular to the optical axis AX of the optical fiber 511, namely the central axis of the core 511a, at specified intervals along the axis. The plurality of the refractive index change parts constitute a fiber grating 521 which reflects light of a specific wavelength and transmits light of the other wavelength. The specific wavelength is determined by the intervals between the plurality of refractive index change parts along the axis, namely the period thereof. The inclination angle of the refractive index change parts is θ with respect to a direction perpendicular to the axis (“angle” hereinafter is an angle with respect to a direction perpendicular to the axis unless otherwise stated).

A transparent member 531 is formed on the cladding 511b around the fiber grating 521. The transparent member 531 has a refractive index which is equivalent to that of the cladding 511a or higher. The refractive index of the transparent member 531 may be the same as that of the core 511a. FIG. 20 is exaggerated in some parts for purposes of illustration, and the ratios of the thickness of the transparent member 531 to the diameter of the fiber grating 521 and so on are different from the reality. The transparent member 531 is made of the same material as the fiber 511, namely glass, or a synthetic resin or an adhesive having a refractive index described above.

The transparent member 531, which has been described as being formed on the cladding 511b, may be configured as shown in a partial cross-sectional view in FIG. 20(c). Namely, cladding in a specified section is removed to expose the core 511a and a reinforcing transparent member 530 is formed in such a manner as to surround the exposed core and the cladding upstream and downstream thereof. The transparent member 531 is formed on the reinforcing transparent member 530. The reinforcing transparent member 530 is made of the same material as the transparent member 531 and formed into a cylindrical shape with an outer diameter which is larger than that of the cladding. Thereby, a high reinforcing effect can be obtained.

The transparent reinforcing member 530 may be integrally formed with the transparent member 531 and directly bonded on the core 511a.

As for the length of the fiber grating 521, the distance L from the first refractive index change part to the last one is about 1-5 mm. The length and thickness of the transparent member 531 is properly determined according to L and θ.

The transparent member 531 has an outer side on which a flat face 531a is formed at an angle of 2θ with respect to a direction perpendicular to the optical axis AX. Two photodetectors 501 and 502 are attached on the flat face 531a. The photodetectors 501 and 502 are arranged symmetrically with respect to the intersection 531aa of a line drawn at an angle of 2θ from the center of the fiber grating 521 and the flat face 531a.

Signal lines from the photodetectors 501 and 502 are connected to an operating unit 311, which calculates the difference of input signals.

The operation of the embodiment according to the invention will be described with reference to the schematic cross-sectional view in FIG. 20(a). Part of light LL having entered the fiber grating 521 through the core 511a of the optical fiber 511 is reflected by the fiber grating 521. When the wavelength of the light LL is λ_{LC}, which is in specific relationship with the period of the refractive index change parts of the fiber grating 521, the light is reflected with maximum intensity at an angle of 2θ. When the wavelength of the light LL is λ_{LC+α}, which is longer than λ_{LC}, the light is reflected at an angle which is larger than 2θ. When the wavelength of the light LL is λ_{LC-α}, which is shorter than λ_{LC}, the light is reflected at an angle which is smaller than 2θ. The intensity of light reflected at an angle which is larger or smaller than 2θ (light of a wavelength of λ_{LC+α} or λ_{LC-α}) is lower than that of the light of a wavelength λ_{LC} reflected at an angle of 2θ.

The specific relationship mentioned above is a relationship expressed by the following equation:

2n_{eff}Λ/cos θ=λ

wherein n_{eff} represents the effective refractive index of the core 511a, Λ represents the interval (period) between the refractive index change parts, and λ represents the wavelength of the light LL. An effective refractive index is a concept derived from the fact that a light beam bounces through the core of a fiber in a zig-zag manner. The following relation holds:

n_{eff}=n·cos α

wherein α represents the angle formed by the traveling direction of a light beam traveling in a zig-zag manner and the central axis of the optical fiber. Namely, assuming that light is transmitted linearly along the axis of the optical fiber, the phase velocity of the light beam increases apparently.

The relation between θ and λ_{LC} expressed using the above equation is as follows:

2n_{eff}Λ/cos θ=λ_{LC}

2n_{eff}Λ/cos(θ+Δθ)=λ_{LC}+Δλ

When the grating is inclined at an angle of θ, the center wavelength of reflection is λ_{LC}, and the light is reflected at an angle of 2θ. When the wavelength deviates from the center wavelength λ_{LC} by ±Δλ, the reflection direction changes by ±Δθ.

In such a configuration, the wavelength of the light LL can be locked to λ_{LC} by detecting the difference between the intensities of the signals from the photodetectors 501 and 502 with the operating unit 311 and adjusting the wavelength of the light LL so that the intensity of the signals may be the same.

The light LL here has been described as being single-wavelength light. This is because only one fiber grating is under consideration. In a system in which a plurality of fiber grating are arranged in series, however, the light LL is multi-wavelength light and the wavelengths of the light LL are locked to λ_{LC}1, λ_{LC}2, and λ_{LC}3, . . . .

The photodetectors 501 and 502 are preferably disposed as symmetrically as possible with respect to the intersection 531aa. However, even if the positions of the photodetectors 501 and 502 are slightly deviated, the wavelength of the light LL can be locked to λ_{LC}′ which is determined depending upon the positions. Description has been made of a case in which the wavelength of the light LL is controlled so that the intensities of the signals from the photodetectors 501 and 502 will be the same. However, the wavelength of the light LL may be controlled so that the intensities of the signals will have a specific relationship. When the intensities of the signals are not the same but have a specific relationship, the wavelength can be locked to a specified wavelength which is deviated from λ_{LC} or λ_{LC}′.

Although the photodetectors 501 and 502 have been described as being attached to the flat face 531a, the face 531a may comprise two flat faces so that lines perpendicular to the light receiving faces of the photodetectors 501 and 502 may pass through the center of the fiber grating 521.

According to this embodiment, a change in wavelength of light shows up as a change in the reflection direction of light, and then as a change in the ratio of light quantities received by the photodetectors 501 and 502. Thus, there is no need for a reference light for compensating a change in the intensity of signal light and an optical splitter and a reference light circuit for it.

Another embodiment will be described with reference to the schematic cross-sectional view in FIG. 20(b). In this embodiment, a transparent member 532 is used instead of the transparent member 531. The transparent member 532 has a face 532a, which corresponds to the flat face 531a of the transparent member 531, shaped in an arc about the center of the fiber grating 521 with a radius of r. A CCD 542 as a photodetector having a light receiving face 542a shaped in an arc which meets the face 532a is attached to the face 532a. Thereby, the wavelength of the light LL can be locked by controlling the wavelength of the light LL based on a signal from the CCD as in the case with the configuration shown in FIG. 20(a).

Referring again to the graph in FIG. 8, the relation between the wavelength of the incident light LL and the quantity of light reflected by the fiber grating 521 will be described. Although the graph shows the characteristic of light reflected by a fiber grating having non-inclined refractive index change parts (θ=0), since the relation between the wavelength of incident light and the wavelength of reflected light is similar, description will be made using the graph for convenience. The wavelength λ of reflected light is determined by the before-mentioned equation:

2n_{eff}Λ/cos θ=λ

As shown in the graph, the fiber grating used here transmits most of light except light of wavelength of around 1546.20 nm and reflects light of wavelength around 1546.20 nm almost completely.

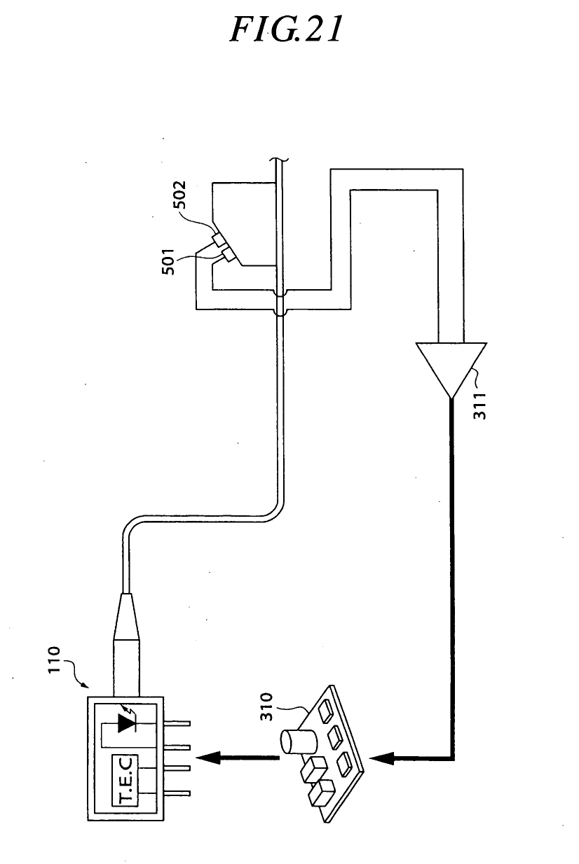

Description will be made of a control system of a wavelength stabilization module for locking wavelength as a fifth embodiment of the invention with reference to the flowchart in FIG. 21. Electric signals sent from the photodetectors 501 and 502 through electric cables are directed into a subtracter 312 (see FIG. 13) in an operating unit 311. The electric signals sent from the photodetectors 501 and 502 through electric cables may be gain-adjusted in a gain adjuster (not shown) and then directed into the subtracter 312 as reference signals. Thereby, it is possible not only to make the intensities of lights received by the photodetectors 501 and 502 the same but also to establish a specific relation therebetween. The result of subtraction in the subtracter 312 is provided to a controller 310 through an electric cable as feedback.

The controller 310 controls the wavelength of the laser beam the light source 110 emits so that the input signals will be zero. The wavelength can be set at a desired value by determining the gain K given in the gain adjuster (not shown).

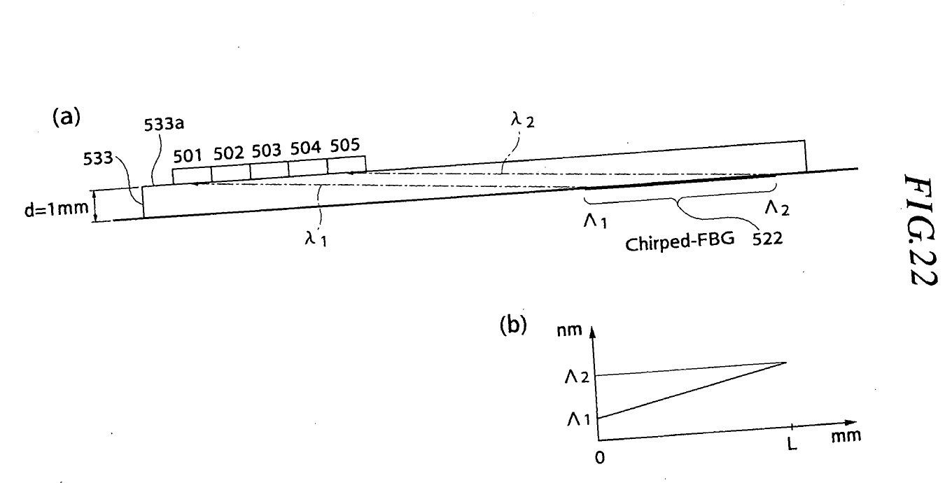

Description will be made of the configuration of another FBG and for use in the wavelength stabilization module as an embodiment of the invention and around it with reference to the schematic cross-sectional view in FIG. 22. The fiber grating used in this embodiment is a so called chirped FBG 522. The chirped FBG 522 is a fiber grating in which the intervals between the refractive index change parts (period) are gradually changed along the optical axis of the optical fiber. Namely, as shown in the graph in FIG. 22(b), the period Λ of the refractive index change parts is simply increases linearly from the period Λ1 of the first refractive index change part (the one in the left end) to the period Λ2 of the last refractive index change part (the one in the right end). In this embodiment, 2θ=10° (θ=5°), and the thickness “d” of a transparent member 533 in a direction perpendicular to the optical axis is 1 mm. In this example a face 533a on which the photodetectors are attached is flat and parallel to the optical axis. A photodetector 501 is attached at the intersection of the face 533a and a straight line drawn at an angle of 10° from the left end of the chirped FBG 522 in the drawing, and photodetector 505 is attached at the intersection of the face 533a and a straight line drawn at an angle of 10° from the right end of the chirped FBG 522 in the drawing. Three photodetectors 502 to 504 are arranged between the photodetectors 501 and 505. Thus, five photodetectors are provided in total.

In the chirped FBG 522, light of a wavelength λ1 (=2n_{eff}Λ1/cos θ) corresponding to the period Λ1 is reflected at an angle of 10° at the left end thereof in the drawing and enters the photodetector 501. Similarly, light of a wavelength λ2 (=2n_{eff}Λ2/cos θ) corresponding to the period Λ2 is reflected at an angle of 10° at the right end thereof in the drawing and enters the photodetector 505.

Thus, when the chirped FBG 522 is used, light of a plurality of wavelengths can be locked with one FBG provided in one optical fiber.

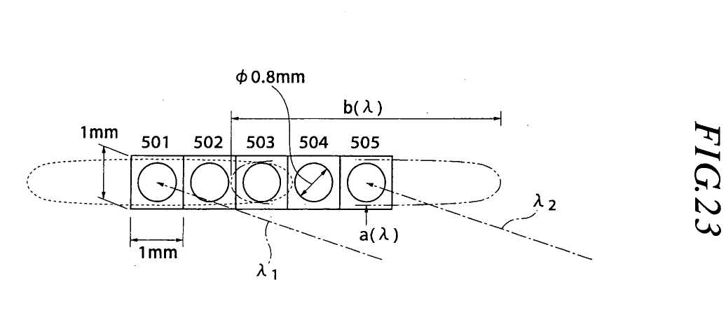

Description will be made of the relation between the photodetectors (501 to 505) and light beams reflected by the chirped FBG 522 with reference to the plan view in FIG. 23. FIG. 23 is a plan view as seen from the side of the light receiving surfaces of the photodetectors. Each of the photodetectors has a size of 1 mm×1 mm and diameter of a right receiving part of 0.8 mm. In such a chirped FBG, the diameter of the beam is represented by the following equations:

a(λ)=2λd/(π·n_{glass}·a_{core}·sin θ)

b(λ)=2λd/(π·n_{glass}·a_{core}·sin² θ)

where

a(λ): minor diameter of the beam,

b(λ): major diameter of the beam,

λ: wavelength of the beam,

d: thickness of the transparent member,

π: circular constant,

n_{glass}: refractive index of the fiber core, and

a_{core}: diameter of the fiber core.

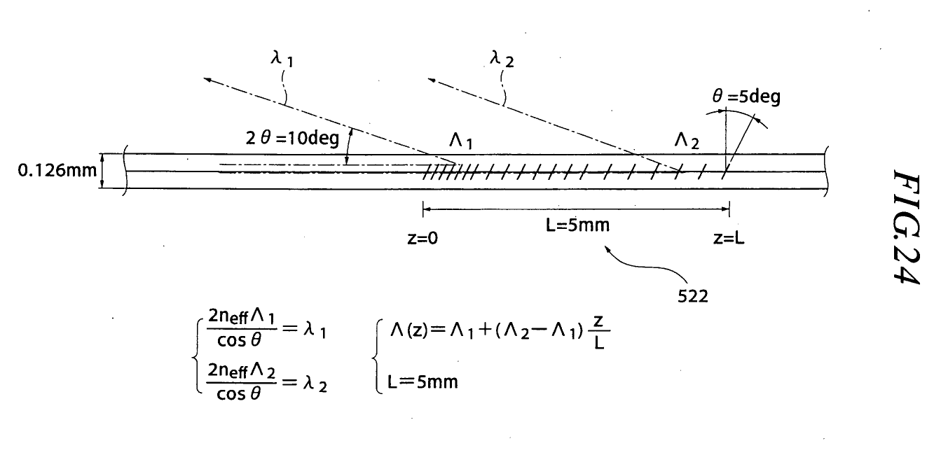

Description will be made of a specific example of the chirped FBG 522 shown in FIG. 22 and FIG. 23 with reference to the schematic cross-sectional view in FIG. 24. In this embodiment, the diameter of the optical fiber is 0.126 mm, the length L of the chirped fiber grating 522 is 5 mm. The beam diameter in this embodiment (the diameter at the time when the intensity of the beam is 1/e²) calculated by substituting specific values into the equation is 1.3 mm (minor diameter)×7.5 mm (major diameter). As the diameter of the light receiving part is 0.8 mm, the beam has a diameter which is slightly larger to can cover the light receiving part and. Although the major diameter is long as compared with the diameter of the right receiving part, there arises no problem when the photodetector detects the center of the beam to make an adjustment since the intensity of the beam follows a Gaussian distribution and is maximum at the center. The “e” is the base of natural logarithm (e≈2.718).

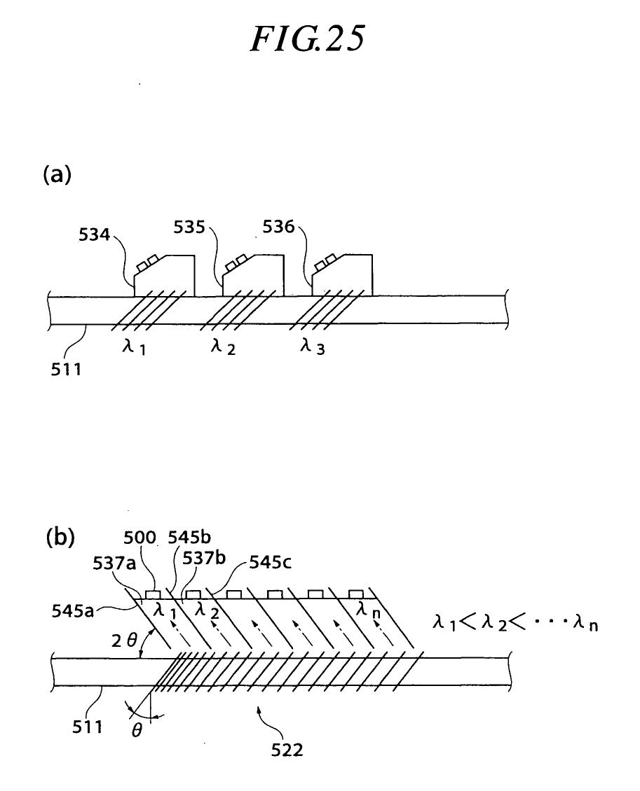

Description will be made of the configurations of other FBGs for an embodiment of the invention and around them with reference to the schematic views in FIG. 25. In the embodiment shown in FIG. 25(a), a plurality of (three in the illustration) fiber gratings having different periods are provided in an optical fiber 511 in series at adequate intervals. The fiber gratings have transparent members 534, 535, and 536 respectively. Two photodetectors are attached to each transparent member as described with FIG. 20. Thereby, lights of wavelengths λ1, λ2, and λ3 corresponding to the periods of the fiber gratings are reflected and the wavelengths are locked to each wavelength by a mechanism described before.

In the embodiment shown in FIG. 25(b), a chirped FBG 522 is formed in the optical fiber 511 and a transparent member 537 is formed outside thereof. The refractive index change parts are inclined at an angle of θ. In the transparent member 537, light shielding partitions 545a, 545b, 545c, . . . are provided at adequate intervals to partition it into a plurality of blocks. The light shielding partitions are provided at an angle of 2θ. No light can be travel between a block 537a defined by the light shielding partitions 545a and 545b and a block 537b defined by the light shielding partitions 545b and 545c. Each of the blocks 537a, 537b, . . . has an outer face on which a photodetector is attached in a manner as described before.

Thereby, each of the photodetectors receives light of a wavelength determined by the period of the refractive index change parts of a corresponding chirped FBG. The lights of each wavelength are separated by the light shielding partitions, so that each light quantity can be accurately measured without being affected by lights in adjacent blocks. A pair of photodetectors may be provided in each block, or one photodetectors may be provided in each block and adjacent two photodetectors may be used as a pair as in the case with photodetectors 501 and 502 in FIG. 20.

In the embodiment shown in FIG. 25(b), the fiber grating has been described as being a chirped FBG. However, the period of the refractive index change parts is fixed in each block and the periods of the blocks may be gradually increased along the traveling direction of the signal light, namely from left to right in the drawing.

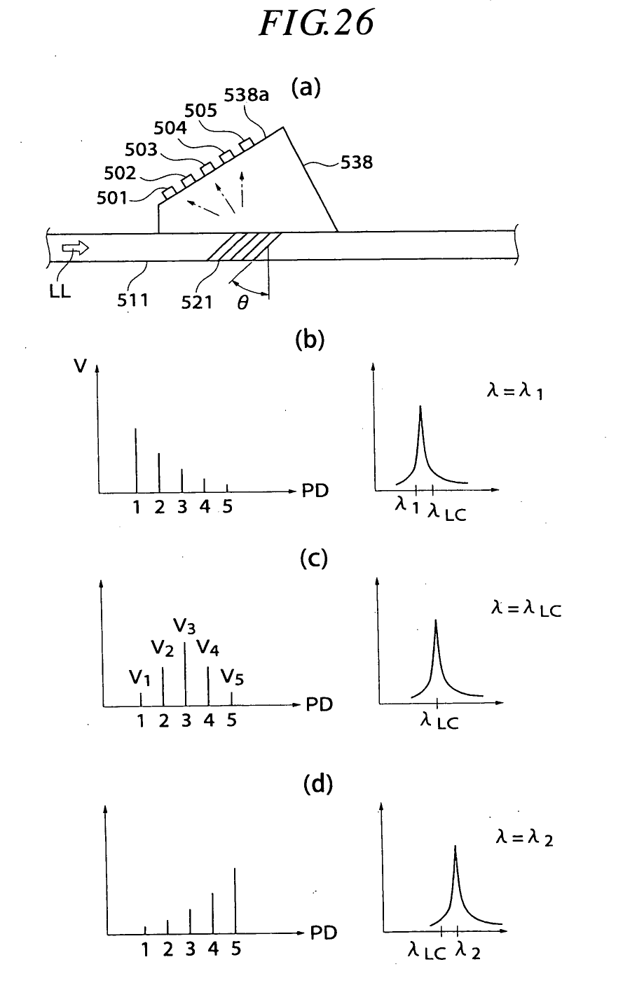

Description will be made of the configuration of another FBG for used in an embodiment of the invention and around it with reference to the schematic cross-sectional view in FIG. 26. In this embodiment, at least three photodetectors (five photodetectors 501 to 505 in the illustration) are attached on a flat face 538a of a transparent member 538 instead of the two photodetectors in FIG. 20. A photodetector 503 is disposed in at an angle 2θ from a fiber grating 521 and the photodetectors 501, 502, 504 and 505 are arranged upstream and downstream of the photodetector 503. The fiber grating 521 is formed in a relatively short section, and can be regarded as a point light source as compared with the extent in which the photodetectors 501 to 505 are arranged.

As shown in FIG. 26(c), in such a configuration, when wavelength λ of the signal light LL passing through the optical fiber 511 is λ_{LC}, the light entering into the photodetector 503 has the highest intensity of V3 (expressed by the output of the detector), followed by intensities V2 and V4 of the lights entering into the photodetectors 502 and 504, respectively, and the intensity of V1 and V5 of the lights entering into the photodetectors 501 and 505 are the lowest. The intensities distributes almost symmetrically with respect to V3.

When the wavelength λ of the signal light LL passing through the fiber 511 is λ1, which is shorter than λ_{LC}, the photodetector which receives the light with the highest intensity sifts from the photodetector 503 to one on the left side therefrom in the drawing as shown in FIG. 26(b). For example, the photodetector 501 receives the light with the highest intensity V1, and the intensities of the light entering into the photodetectors 502 to 505 decreases in this order.

When the wavelength λ of the light LL is λ2, which is longer than λ_{LC}, the situation is inverse of the situation shown in FIG. 22(b) as shown FIG. 22(d). Namely, the photodetector which receives the light with the highest intensity sifts from the photodetector 503 to one on the right side therefrom. For example, the photodetector 505 receives the light with the highest intensity V5, and the intensities of the light entering into the photodetectors 504 to 501 decreases in this order.

When at least three photodetectors are provided and an adjustment is made so that the output of photodetector in the center will be the highest, the wavelength of the signal light can be locked to a desired wavelength.

At this time, weights a1, a2, a3, a4 and a5 may be given to the outputs of the photodetectors, respectively. Namely, P1 is calculated as follows:

P1=a1·V1+a2·V2+a3·V3+a4·V4+a5·V5

The values a1 to a5 are set to values which simply increase or decrease. For example, a1 to a5 are determined as follows: a1=5, a2=10, a3=15, a4=20, and a5=25. Thereby, it is possible to judge whether the wavelength λ is longer or shorter than λ_{LC} by the increase or decrease in P1. When P2 is set to (a1·V1+a2·V2+a3·V3+a4·V4+a5·V5)/(V1+V2+V3+V4+V5), a change in the wavelength can be accurately detected by the increase or decrease in P2 since the value P2 is not affected even when the intensity of the light LL is varied for some reason.

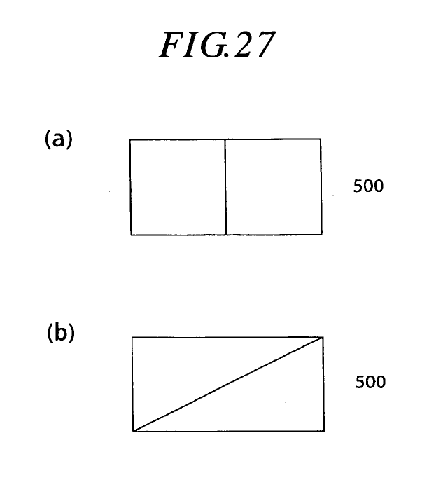

Description will be made of examples of the photodetector with reference to the schematic views in FIG. 27. FIG. 27(a) is a plan view of two square photodetectors arranged side by side. Description of the above embodiments has been made on the premise that such photodetectors are used therein (the situation is similar when three or more photodetectors are used). FIG. 27(b) is a plan view of a combination photodetector in which a rectangular photodetector is divided by a diagonal line into two photodetectors. In such a combination photodetector, since the size of the light receiving faces of the two photodetectors are gradually changed from small to large (or from large to small) along the longitudinal direction of the combination photodetector, a change in position of the beam can be continuously detected.

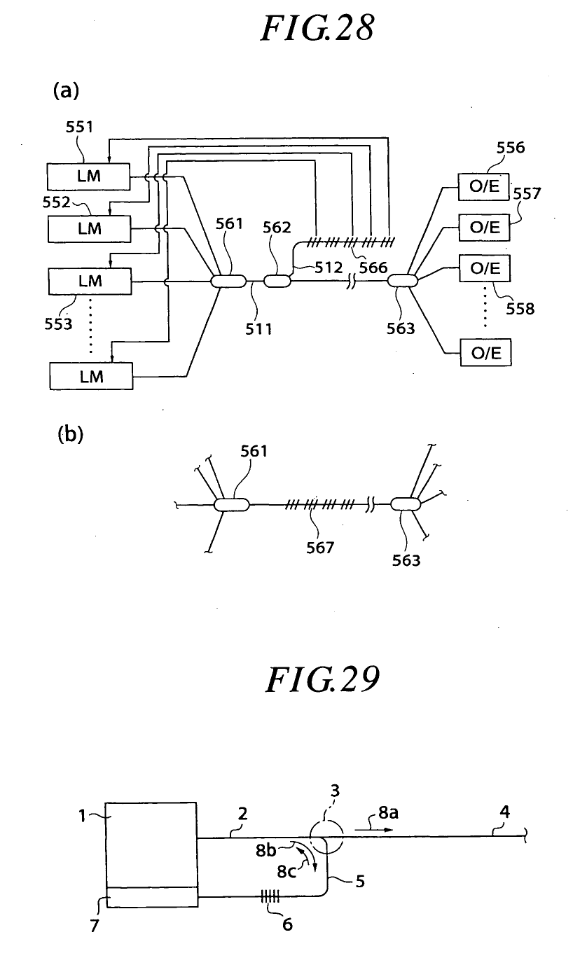

Description will be made of an optical communication system using a wavelength stabilization module described above with reference to the flowchart in FIG. 28. The optical communication system as a sixth embodiment comprises a plurality of laser modules LM551 to LM553, a joiner 561 for combining a plurality of optical fibers for directing lights from the laser modules LM551 to LM553 into an optical fiber 511, a splitter 562 for branching an optical fiber 512 for reference light from the optical fiber 511, a splitter 563 for splitting the optical fiber 511 into a plurality of optical fibers on the side of user terminals, and a plurality of photoelectric converters (0/Es) 556 to 558 connected to the split optical fibers as shown in FIG. 28(a). The photoelectric converters convert an optical signal into an electric signal which can be used in terminal devices such as personal computers. As the splitters, optical couplers described above can be used.

A plurality of fiber gratings 566 are formed in the optical fiber 512. A signal is provided from each fiber grating to the corresponding laser module LM through an operating unit (subtracter) as feedback. Thereby, the wavelength from each laser module LM is controlled, namely locked, to a desired wavelength.

In FIG. 28(a), the transparent members, photodetectors and the operating unit as components of the wavelength stabilization module are omitted and illustrated as fiber gratings 566.

Description will be made of an optical communication system as a seventh embodiment with reference to FIG. 28(b). This system is different from the system in FIG. 28(a) in that the splitter 562 and the optical fiber 512 for reference light are not provided. In FIG. 28(b), parts similar to those in FIG. 28(a), namely the laser modules and photoelectric converters are omitted. The fiber gratings 567 are directly formed in the optical fiber 511 for signal light. Inclined fiber grating can be formed in an optical fiber for signal light since only small quantity of light is reflected and extracted to the outside.

As has been described above, according to the wavelength stabilization module of an embodiment of the invention, fiber gratings can be formed in series in one optical fiber or in an optical fiber for signal light. Thus, the structure can be simplified and the manufacturing cost can be reduced. According to an optical communication system using the wavelength stabilization module according to an embodiment of the invention, the structure can be simplified and the manufacturing cost can be reduced.

As has been described above, the wavelength stabilization module according to an embodiment of the invention comprises a fiber grating having refractive index change parts inclined with respect to a direction perpendicular to the optical axis of the fiber and a transparent member formed on the cladding around the fiber grating, so that part of signal light transmitted through the core can be reflected and extracted to the outside. Also, the wavelength stabilization module is provided with at least two photodetectors arranged on the outside of transparent member along the optical axis, so that the quantity of the extracted light can be detected. Therefore, there can be provided a wavelength stabilization module and an optical communication system which use a fiber grating and can lock the wavelength of light with a simple configuration.

The wavelength stabilization module does not need an optical splitter for extracting reference light from a fiber for extracting a monitor signal in contrast to conventional wavelength stabilization modules and thus is simple in structure.

An optical communication system using the wavelength stabilization module according to an embodiment of the invention does not have to be provided with an optical splitter for locking the wavelength of the light generated by a laser module and thus simple in structure. Therefore, there can be provided a wavelength stabilization module and an optical communication system which use a fiber grating and can lock the wavelength of light with a simple configuration.

Industrial Applicability

As has been described above, according to the invention, light reflected by a fiber grating is directed to the outside of the fiber. Therefore, there can be provided a wavelength stabilization module which can restrain the reflected light from returning to a laser source.

1. A wavelength stabilization module, comprising:
an optical splitter for splitting light lead from a light source through a fiber into first and second lights;
a fiber grating which has light of a specific wavelength in said first light pass therethrough and reflects light of the other wavelengths in said first light; and
a light quantity change operating unit for detecting a change in quantity of light passing through said fiber grating using said second light as reference light;
said wavelength stabilization module being configured to direct light, reflected by said fiber grating, to the outside of said fiber; and
being configured to feed back said detected change in light quantity to said light source.

2. The wavelength stabilization module as claimed in claim 1, wherein said configuration for directing light reflected by said fiber grating to the outside of said fiber is a refractive index change part arranged inclined with respect to the optical axis of a fiber in which said fiber grating is formed.

3. The wavelength stabilization module as claimed in claim 1 or 2, further comprising reflected light removing means for removing reflected light directed from said fiber grating toward said light source.

4. The wavelength stabilization module as claimed in claim 3, wherein said reflected light removing means is a high-refractive index material layer provided on a surface of a cladding layer constituting said fiber between said fiber grating and said light source.

5. The wavelength stabilization module as claimed in claim 4, wherein said high-refractive index material layer is provided on the outer side of a bent portion of said fiber.

6. The wavelength stabilization module as claimed in claim 4, wherein said optical splitter is an optical coupler formed by fusing cores of two fibers and said high-refractive index material layer is provided on a taper portion on the side of said fiber grating located in the vicinity of the fused region of said fibers.

7. The wavelength stabilization module as claimed in claim 3, wherein said reflected light removing means is a cladding layer-removed section provided in said cladding layer constituting said fiber between said fiber grating and said light source.

8. The wavelength stabilization module as claimed in claim 7, wherein said cladding layer-removed section has a cladding layer left to cover the core.

9. The wavelength stabilization module as claimed in claim 8, wherein a high-refractive index material is filled in said cladding layer-removed section in place of the removed cladding layer.

10. A stable wavelength laser beam generating device, comprising:
a wavelength stabilization module according to any one of claims 1 to 9;
a light source for generating a laser beam to be supplied to said wavelength stabilization module; and
a controller for controlling the wavelength of said laser beam which said light source generates according to said change in light quantity provided as feedback.

11. A wavelength stabilization module, comprising:
a first optical splitter for splitting an input signal into a main signal and a monitor signal at a first specified splitting ratio;
a second optical splitter which receives said monitor signal and splits said monitor signal into an FBG input signal and a termination signal at a second specified splitting ratio; and
a fiber grating formed in an optical fiber for transmitting said FBG input signal;
wherein said first and second specified splitting ratios are so selected that light reflected by said fiber grating may be sufficiently attenuated with respected to said input signal in returning through the second optical splitter and the first optical splitter in the direction from which said input signal came.

12. The wavelength stabilization module as claimed in claim 11, wherein said first and second specified splitting ratios are respectively 90% or more to 10% or less.

13. The wavelength stabilization module as claimed in claim 11 or 12, wherein said second optical splitter is provided with a first photodetector for measuring light passing through said fiber grating and a second photodetector for measuring light reflected by said fiber grating.

14. The wavelength stabilization module as claimed in any one of claims 11 to 13, wherein said termination signal is terminated.

15. A stable wavelength laser beam generating device, comprising:
a wavelength stabilization module according to any one of claims 11 to 14;
a laser source for generating a laser beam to be supplied to said wavelength stabilization module; and
a controller which receives light processed by said wavelength stabilization module and controls the wavelength of said laser beam which said laser source generates.

16. The stable wavelength laser beam generating device as claimed in claim 15,
wherein said fiber grating is a reflective fiber grating,
wherein said second optical splitter is provided with a first fiber input side port for inputting said monitor signal and a second fiber input side port for outputting signal light reflected by said reflective fiber grating as a monitor output, and
wherein said controller receives reference light passing through said reflective fiber grating and signal light output from said second fiber input side port as a monitor output and feeds back a wavelength control signal for controlling the wavelength of said laser source to said laser source to stabilize the wavelength of said laser beam from said laser source within a wavelength band used as a signal band.

17. The stable wavelength laser beam generating device as claimed in claim 15,
wherein said fiber grating is a passing through type fiber grating,
wherein said second optical splitter is provided with a first fiber input side port for inputting said monitor signal and a second fiber input side port for outputting reference light reflected by said passing through type fiber grating as a monitor output, and
wherein said controller receives signal light passing through said passing through type fiber grating and a reference light output from said second fiber input side port as a monitor output and feeds back a wavelength control signal for controlling the wavelength of said laser source to said laser source to stabilize the wavelength of said laser beam from said laser source within a wavelength band used as a signal band.

18. The stable wavelength laser beam generating device as claimed in claim 16 or 17, wherein said controller receives an output value from a signal light detector which receives said signal light and an output value from a reference light detector which receives said reference light and executes the following calculation to normalize the wavelength of said signal light with respect to a wavelength band used as a signal band:
Γ=(PD1−PD2)/(PD1+PD2)
wherein Γ represents an index obtained by normalizing the wavelength of the signal light with respect to a wavelength band used as a signal band, PD1 represents an output value from said signal light detector, and PD2 represents an output value from said reference light detector.

19. A wavelength stabilization module, comprising:
a fiber grating having a refractive index change part provided in an optical fiber having a core of a specified refractive index and a cladding of a refractive index which is lower than that of said core and inclined with respect to the optical axis of said optical fiber;
a transparent member formed on said core of said fiber grating; and
at least two photodetectors provided on said transparent member and arranged along said optical axis.

20. The wavelength stabilization module as claimed in claim 19, further comprising a controller which compares outputs from said at least two photodetectors to control the wavelength of light reflected by said fiber grating.

21. The wavelength stabilization module as claimed in claim 19 or 20, comprising a plurality of fiber gratings which reflect lights of different wavelength each other, arranged in series in a direction of the optical axis of said optical fiber.

22. An optical communication system comprising:
a wavelength stabilization module according to claim 21;
a plurality of laser modules; and
an optical joiner for combining signal lights from said plurality of laser modules,
wherein said plurality of fiber gratings are formed in an optical fiber on the output side of said optical joiner.
